(19) United States
(12) Patent Application Publication
(10) Pub. No.: US 2026/0323469 A1
(43) Pub. Date: Oct. 15, 2026

(54) Capability Signaling for Conditional Cell Switching Without Random Access

(71) Applicant: Ofinno, LLC, Reston, VA (US)

(72) Inventors: Ali Cagatay Cirik, Chantilly, VA (US); Esmael Hejazi Dinan, McLean, VA (US); Taehun Kim, Fairfax, VA (US)

(73) Assignee: Ofinno, LLC, Reston, VA (US)

(21) Appl. No.: 19/688,946

(22) Filed: May 27, 2026

Related U.S. Application Data
(63) Continuation of application No. PCT/US2025/052166, filed on Oct. 23, 2025.
(60) Provisional application No. 63/717,872, filed on Nov. 7, 2024.

(51) Int. Cl. H04W 36/36

(52) U.S. Cl. CPC H04W 36/362

(57) ABSTRACT

A wireless device transmits one or more capability information messages indicating that the wireless device supports conditional layer-1/layer-2 triggered mobility (LTM) cell switching and supports random access channel (RACH)-less conditional LTM with an uplink configured grant for a master cell group (MCG). The wireless device receives one or more radio resource control (RRC) messages comprising configuration parameters of a candidate cell for conditional LTM cell switching. The configuration parameters indicate a first uplink configured grant configuration for performing a RACH-less LTM cell switch to the candidate cell. The wireless device triggers a conditional LTM cell switch of a primary cell to the candidate cell in response to a condition being fulfilled. The wireless device transmits, on the candidate cell and for the conditional LTM cell switch, an uplink transmission based on the first uplink configured grant configuration.

### CROSS-REFERENCE TO RELATED APPLICATIONS

This application is a continuation of International Application No. PCT/US2025/052166, filed Oct. 23, 2025, which claims the benefit of U.S. Provisional Application No. 63/717,872, filed Nov. 7, 2024, each of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIGS. 17A and 17B are signal flow diagrams illustrating aspects of transmission configuration indicator (TCI) state indication according to the present disclosure.

FIG. 18 is a signal flow diagram illustrating aspects of layer-1/layer-2 triggered mobility (LTM) according to the present disclosure.

FIG. 19 is a signal flow diagram illustrating aspects according to the present disclosure.

FIG. 20 is a flowchart illustrating aspects of a process performed by a wireless device according to the present disclosure.

FIG. 21 is a flowchart illustrating aspects of a process performed by a base station according to the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality, and advantages, are presented for example purposes only. The disclosed architecture is sufficiently flexible and configurable, such that it may be utilized in ways other than those shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B ={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect or implement the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, MATLAB or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

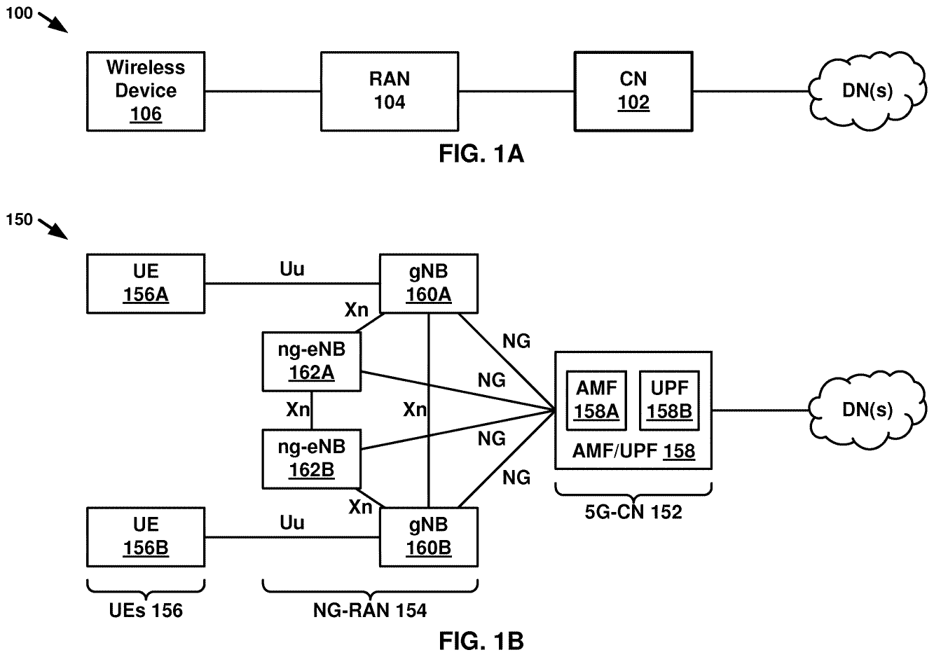

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

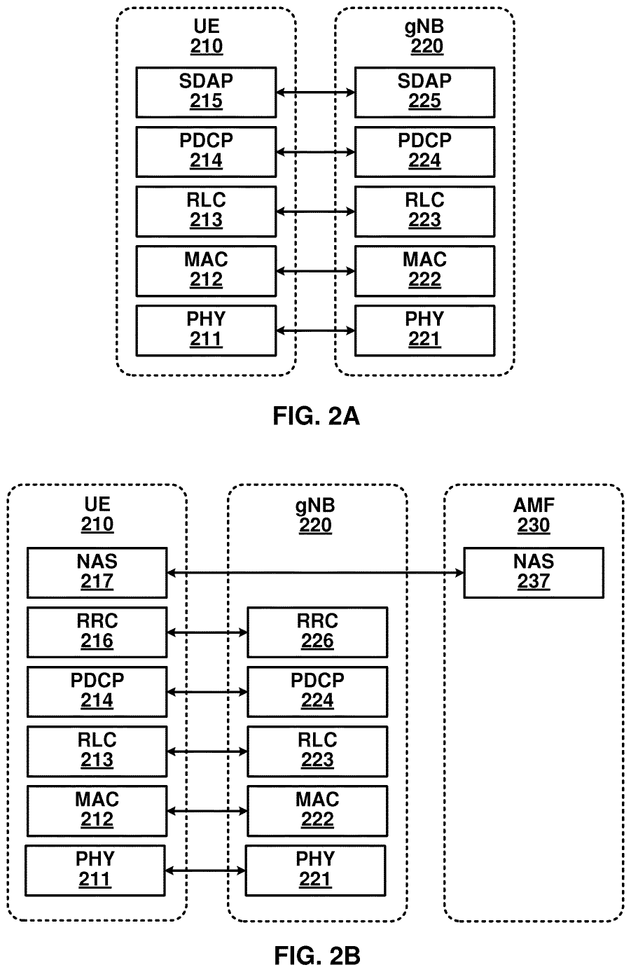

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise medium access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

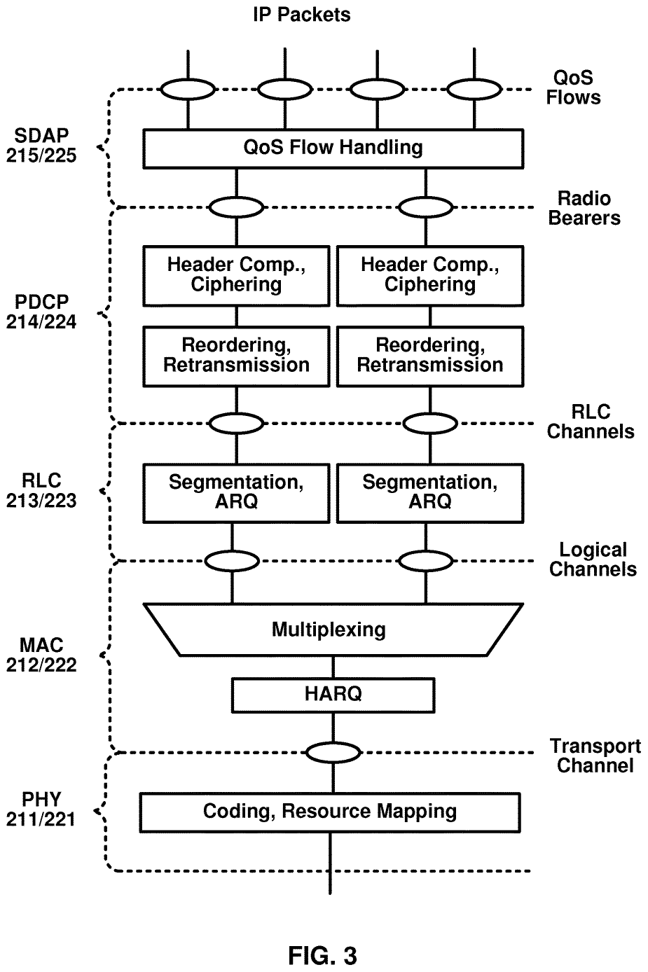

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

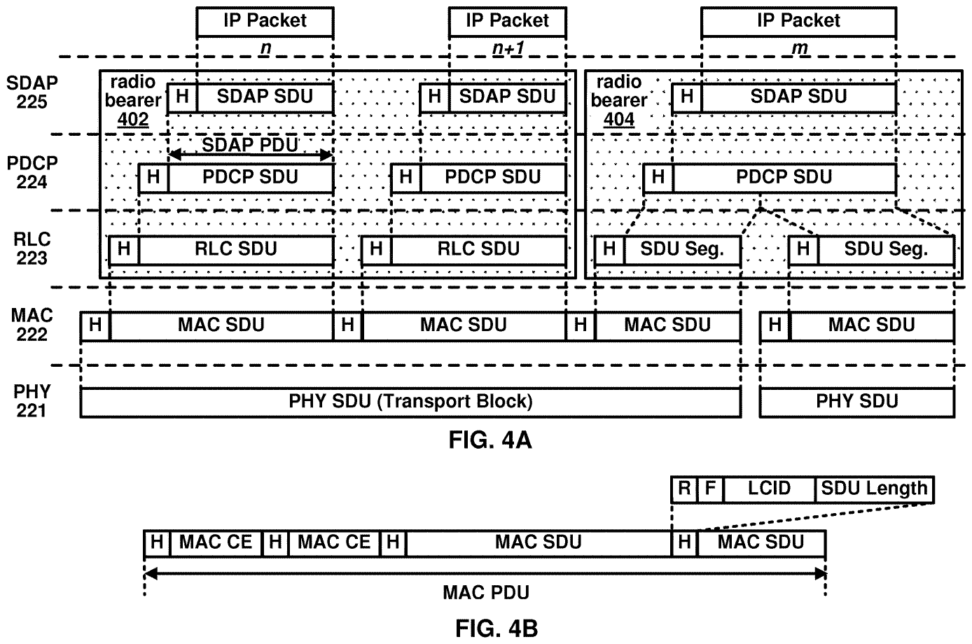

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

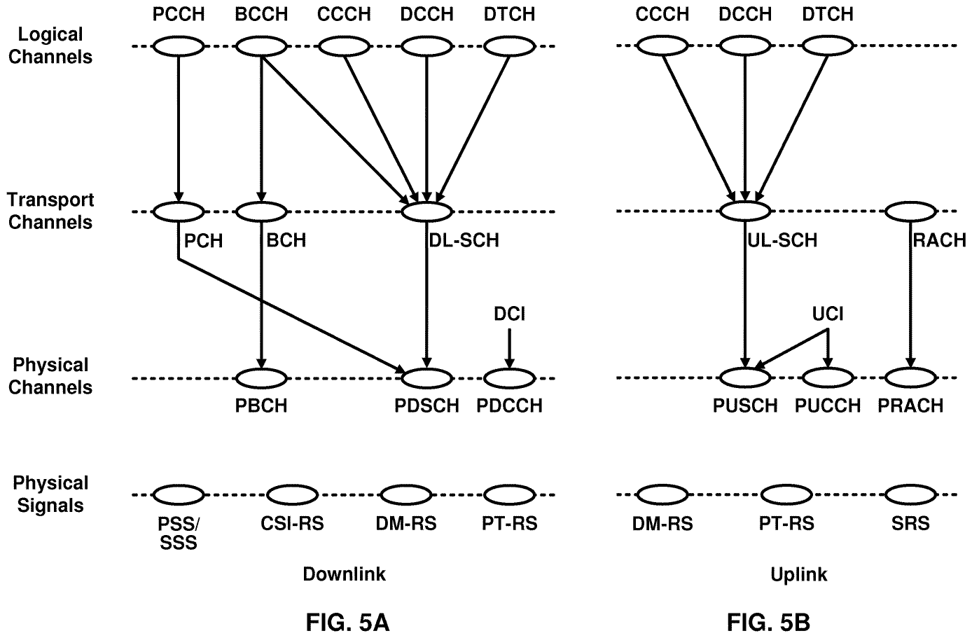

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

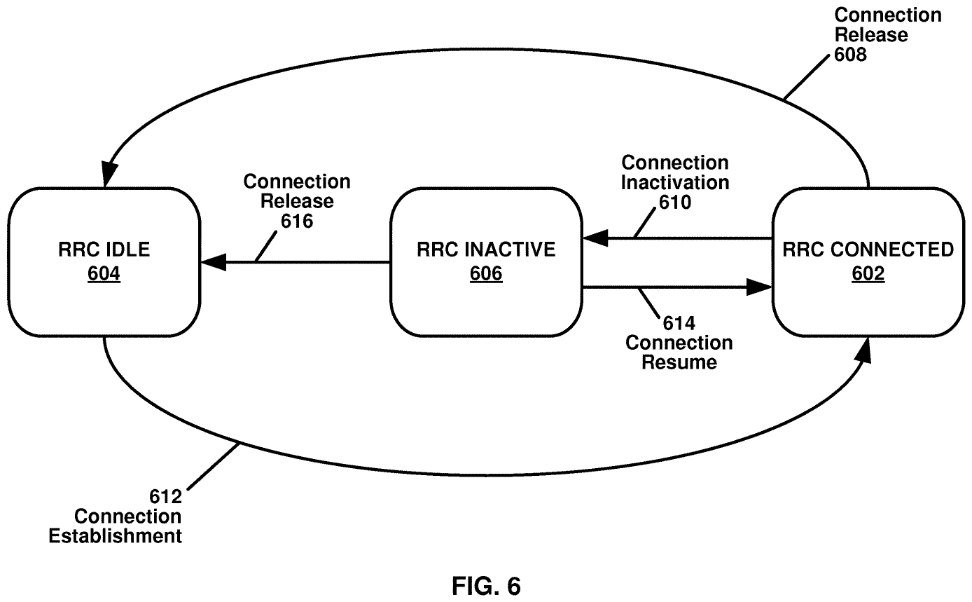

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

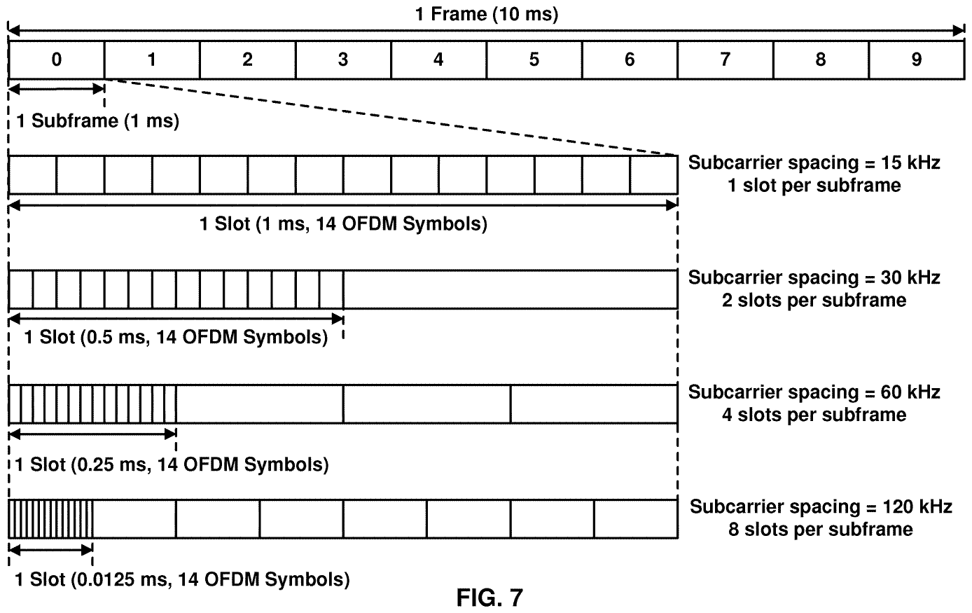

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

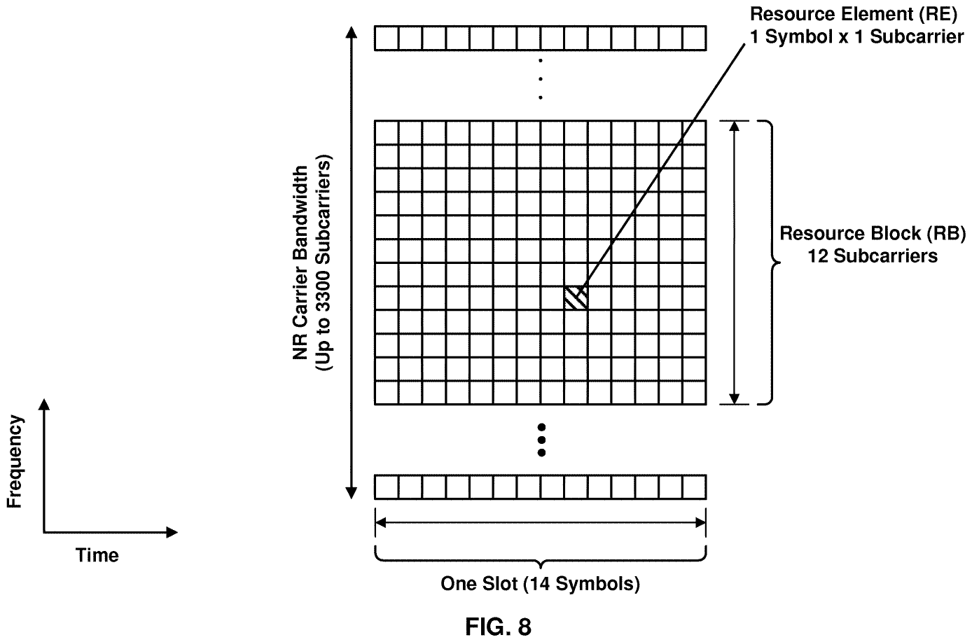

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

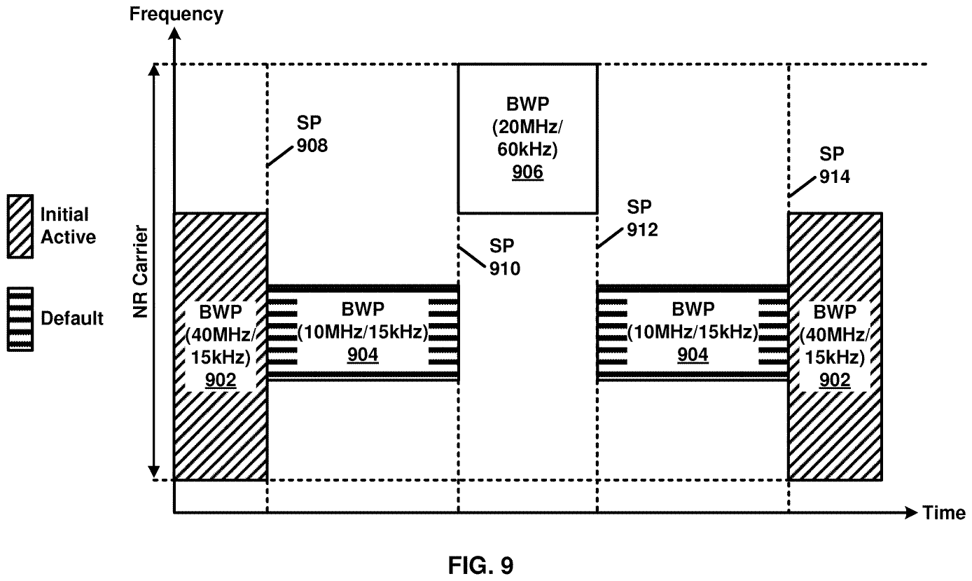

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

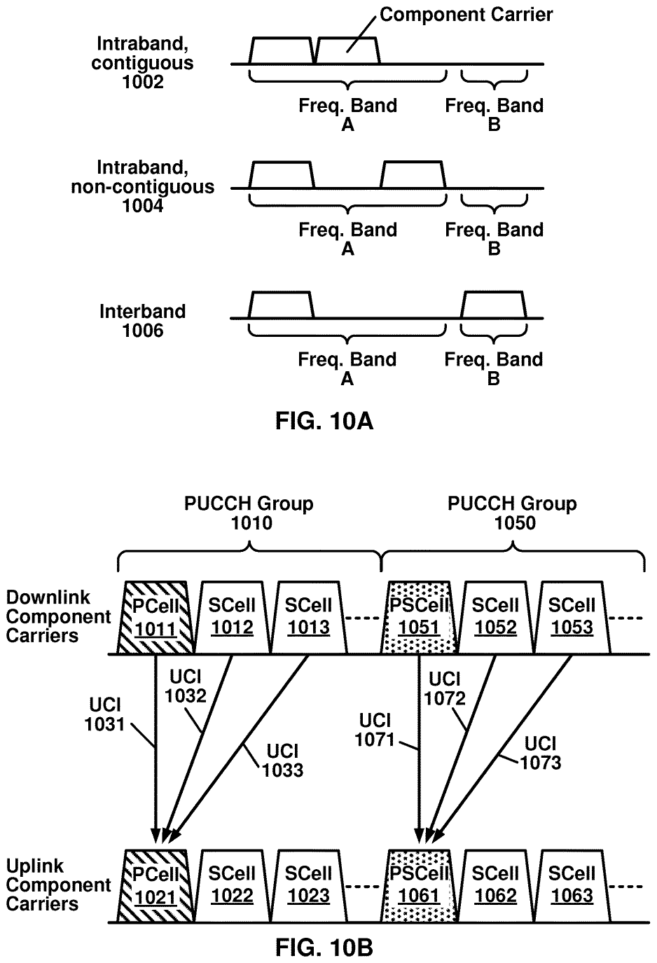

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

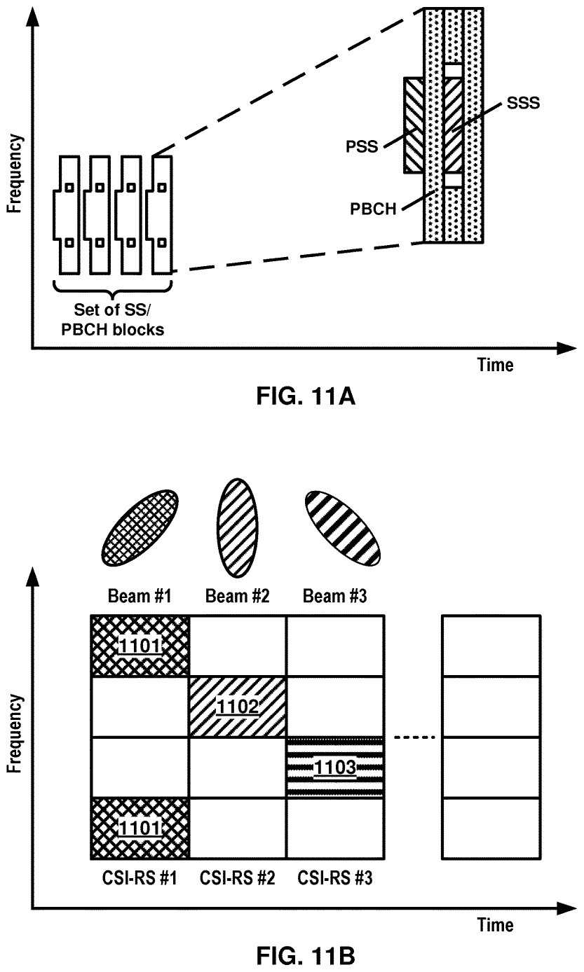

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

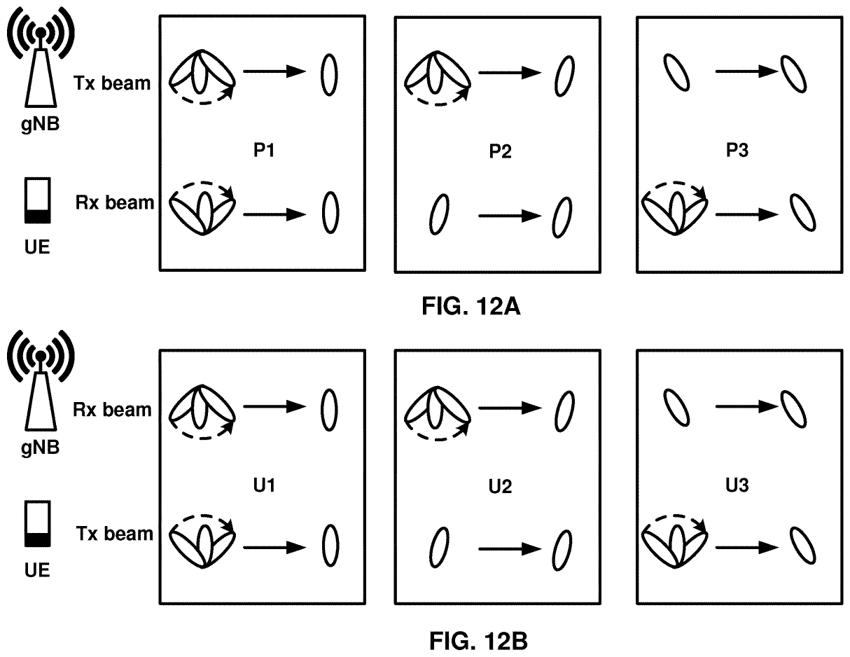

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

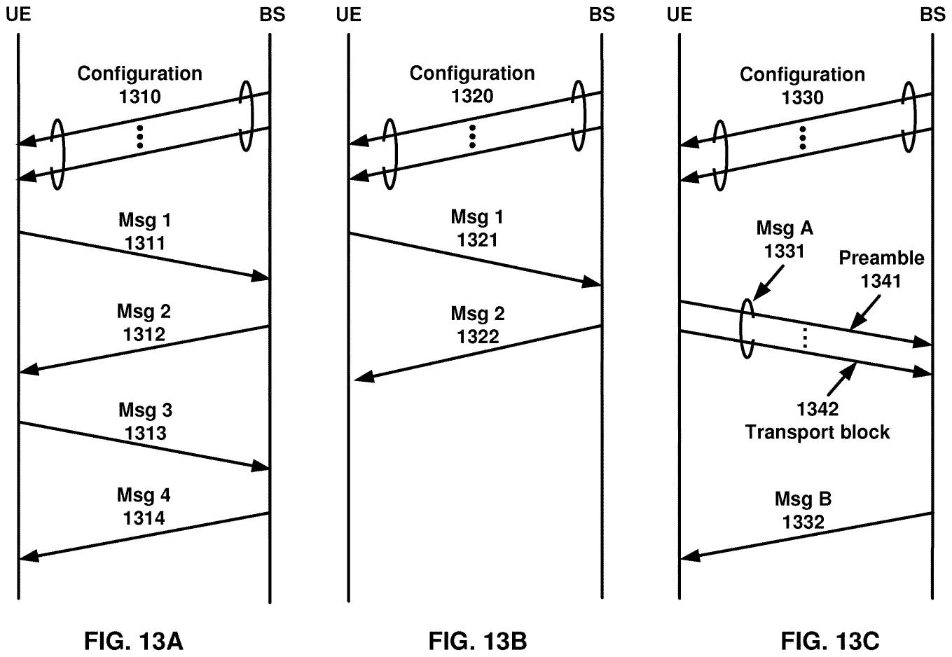

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id, where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

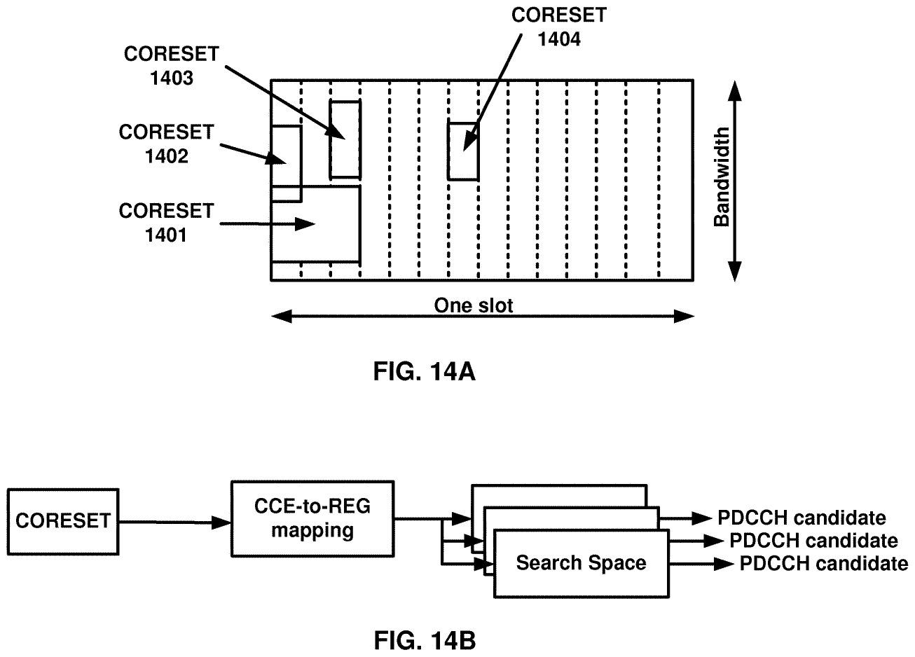

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

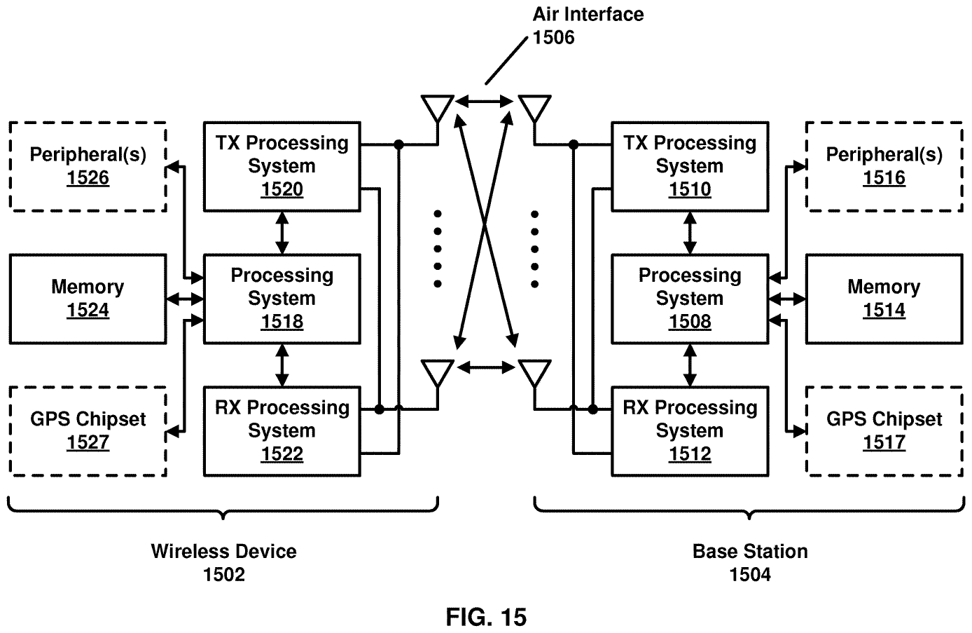

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 maybe associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

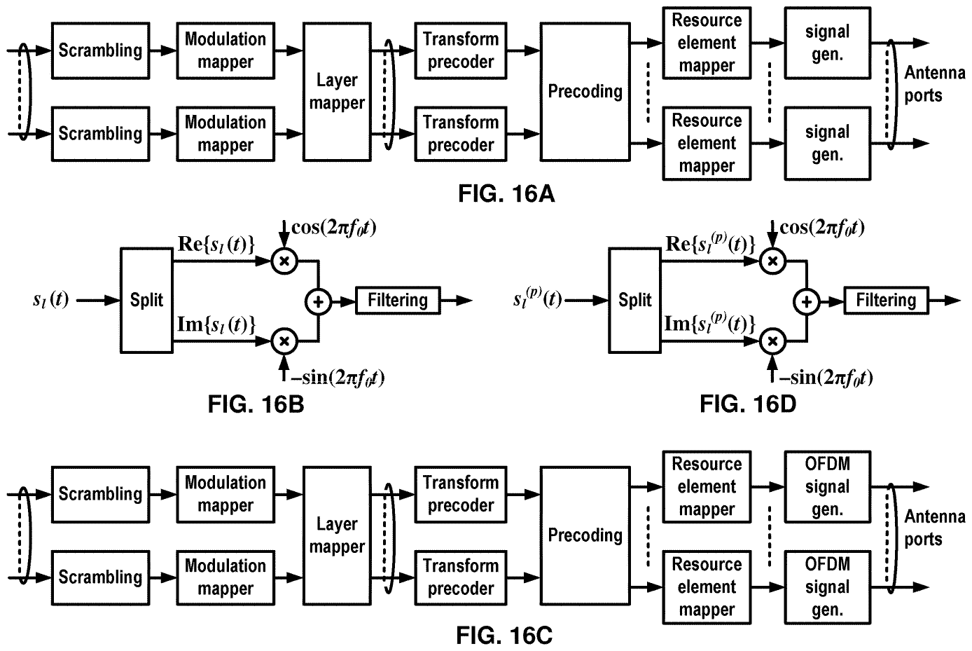

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry (or expiration) of a random access response window timer, the time difference between two time stamps may be used. When a timer is restarted, a process for measurement of time window may be restarted. Other example implementations may be provided to restart a measurement of a time window.

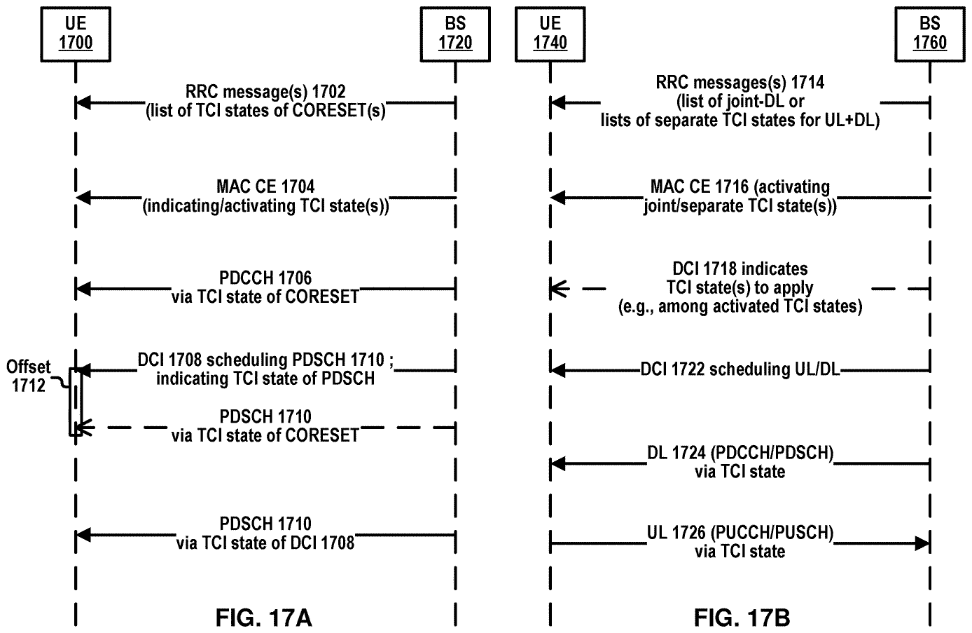

FIGS. 17A and 17B illustrate examples procedures for beam indication based on TCI states. FIG. 17A illustrates an example of a wireless device 1700 receiving, from a base station 1720, channel-specific beam indications for separate downlink physical channels, such as the PDCCH and the PDSCH. FIG. 17B illustrates an example of a wireless device 1740 receiving, from a base station 1760, beam indications applicable to multiple physical channels (i.e., common among physical channels), such as TCI states for downlink receptions and/or uplink transmissions. This approach of using a TCI state for multiple physical channels as illustrated in FIG. 17B may be referred to as a unified TCI state framework.

As illustrated in FIG. 17A, wireless device 1700 receives one or more RRC messages 1702 from base station 1720. One or more RRC messages 1702 may indicate one or more TCI states for one or more CORESETs. For example, one or more RRC messages 1702 may comprise a list of TCI states (e.g., a list of IDs of TCI states) for CORESETs of wireless device 1700.

Each TCI state may indicate one or more reference signals. For example, each TCI state may comprise one or more IDs of one or more reference signals. The one or more reference signals of a TCI state may be used for channel estimation (including beam determination) such that a signal that is quasi co-located (QCL'ed) with the reference signal of a TCI state may experience the same channel conditions (e.g., channel distortions) and properties as the reference signal of the TCI state. As the reference signal is a known sequence (e.g., a pilot signal), the effects of the channel on the signal may be inferred from the effects of the channel on the reference signal.

A TCI state may indicate which, so-called, large-scale channel properties may be inferred from the QCL association between a signal and a reference signal indicated by a TCI state. To do so, each of the one or more reference signals indicated by a TCI state may be associated with a QCL type. In an example, there may be four QCL types, such as QCL Type-A, QCL Type-B, QCL Type-C, and QCL Type-D. QCL Type-A may be used to estimate Doppler shift, Doppler spread, average delay, and delay spread. QCL Type-B may be used to estimate Doppler shift and Doppler spread. QCL Type-C may be used to estimate average delay and Doppler shift. QCL Type-D may be used for spatial domain parameters (e.g., one or more parameters for spatial domain filters, and/or QCL relationships between antenna ports, used to receive downlink signals).

A reference signal of a TCI state with a QCL type of QCL Type-D may be used for beam determination. For example, when a signal is quasi co-located with a reference signal of a TCI state with QCL Type-D, wireless device 1700 may determine (e.g., assume or infer) that base station 1720 applies the same spatial (domain) filter to both the signal and the reference signal of the TCI states. By being able to determine (e.g., assume or infer) the spatial domain (transmission) filter applied by base station 1720 to a signal (from the spatial domain filter applied to the QCL'd reference signal), wireless device 1700 may apply a spatial domain (reception) filter suitable to receive the signal. The spatial domain filter used to receive a downlink signal may be referred to as a spatial filter, a spatial domain filter parameter, a spatial domain reception filter, quasi co-location of (e.g., antenna ports of) a downlink signal with (e.g., antenna ports of) a reference signal. The quasi co-location of the downlink signal with the reference signal may be referred to as a QCL assumption, a QCL relationship, and/or QCL information.

Returning to FIG. 17A, wireless device 1700 receives one or more RRC messages 1702 that indicate TCI states. For example, one or more RRC messages 1702 may comprise a list of TCI states of a CORESET (e.g., a list of IDs of TCI states). Wireless device 1700 may use the TCI states in the list for receiving PDCCHs on the CORESETs. The TCI states indicated by one or more RRC messages 1702 may be referred to as configured TCI states or RRC-configured TCI states.

FIG. 17A illustrates that wireless device 1700 receives MAC CE 1704 from base station 1720. MAC CE 1704 may indicate, or activate, one or more TCI states configured by one or more RRC messages 1702. For example, MAC CE 1704 may indicate a (e.g., single) TCI state for one or more CORESETs (e.g., for PDCCH receptions via the one or more CORESETs). As another example, MAC CE 1704 may activate a plurality of TCI states that may be used (applied) for PDCCH receptions via CORESETs. The TCI states indicated by MAC CE 1704 may be referred to as activated TCI states or MAC-CE activated TCI states.

Wireless device 1700 may determine one or more spatial domain filter parameters (e.g., QCL information) based on a reference signal indicated by the TCI state. For example, FIG. 17A illustrates that wireless device 1700 receives PDCCH 1706, of a CORESET, via a TCI state of the CORESET.

For PDSCH reception, a DCI may be used to indicate which TCI state, among the TCI states (e.g., for the CORESETs) activated by MAC CE 1704, wireless device 1700 is to use (apply) for receiving PDSCH receptions (e.g., data, transport blocks, code block groups of a transport block). As illustrated, wireless device 1700 receives DCI 1708. DCI 1708 schedules a PDSCH reception 1710 and indicates which TCI state, among the activated TCI states, wireless device 1700 is to use (apply) for receiving PDSCH reception 1710. A TCI state indicated by a DCI may be referred to as an indicated TCI state. Similarly, a TCI state indicated by a MAC CE that indicates a single TCI (e.g., one TCI state) state may be referred to as an indicated TCI state.

Although DCI 1708 indicates a TCI state to use for receiving PDSCH reception 1710, wireless device 1700 may apply a different TCI state depending on an offset (e.g., in time) between receiving DCI 1708 and PDSCH reception 1710. For example, DCI 1708 may schedule PDSCH reception 1710 within an offset 1712. Offset 1712 may be referred to as a scheduling offset. Offset 1712 may be a duration or a number of symbols. Offset 1712 may be based on a UE-capability of wireless device 1700.

Based on DCI 1708 scheduling PDSCH reception 1710 within offset 1712, wireless device 1700 may apply the TCI state of the CORESET (e.g., instead of the TCI state indicated by DCI 1708). That is, wireless device 1700 applies the TCI state used to receive PDCCH 1706 (e.g., and does not apply the TCI state indicated by DCI 1708 for receiving PDSCH reception 1710).

Within offset 1712, wireless device 1700 may be unable to (successfully) decode DCI 1708, update the spatial filtering, and/or retune RF chains in time for receiving PDSCH reception 1710. By using the TCI state of the CORESET used to receive PDCCH 1706 (instead of the TCI state indicated in DCI 1708 for receiving the PDSCH reception 1710), this allows wireless device 1700 to receive PDSCH reception 1710 within offset 1712.

On the other hand, when, e.g., PDSCH reception 1710 is scheduled after offset 1712, wireless device 1700 may apply the TCI state indicated by DCI 1708 for receiving PDSCH reception 1710. For example, FIG. 17A illustrates that wireless device 1700 receives, from base station 1720, PDSCH reception 1710 via the TCI state indicated by DCI 1708. As another example (e.g., regardless of offset 1712), in response to DCI 1708 not comprising a field indicating a TCI state (any TCI state) for PDSCH reception 1710 (e.g., based on a DCI format of DCI 1708, such as DCI 1_0), wireless device 1700 may apply the TCI state of the CORESET for PDSCH reception 1710.

In the example illustrated in FIG. 17A, base station 1720 may transmit separate beam indications for the PDCCH and the PDSCH, along with separate beam indications for each PDSCH transmission. FIG. 17B illustrates an example of a unified TCI state framework. Under the unified TCI state framework, a single TCI state (or a set of TCI states) may be indicated for each of the downlink physical channels, such as a single TCI state is applied to both PDCCH and PDSCH transmissions. A TCI state that is applied to both the PDCCH and PDSCH may be referred to as a downlink TCI state (or a joint-downlink TCI state). For uplink beam indications under the unified TCI state framework, a TCI state (or a set of TCI states) may be indicated for each of the uplink physical channels, such as a single TCI state is applied to both PUCCH and PUSCH transmissions. A TCI state that is applied to both the PUCCH and PUSCH may be referred to as an uplink TCI state.

In addition to providing TCI states that are applied to each of the physical channels in the downlink or uplink, the unified TCI state framework may also be used to indicate a single TCI state (or a set of TCI states) for both downlink and uplink. That is, the TCI state is applied to each of the downlink and uplink physical channels, such as the PDCCH, PDSCH, PUCCH, and PUSCH. A TCI state that is applicable to both downlink and uplink may be referred to as a joint TCI state, a joint-downlink TCI state, a joint DL/UL TCI state, or a common TCI state. A TCI state applicable to the unified TCI state framework may be referred to as a unified TCI state.

As an example of the unified TCI state framework, FIG. 17B illustrates that wireless device 1740 receives, from base station 1760, one or more RRC messages 1714. One or more RRC messages 1714 indicates a plurality of TCI states. The plurality of TCI states may be a plurality of unified TCI states. As an example, one or more RRC messages 1714 may comprise a list of TCI states. The list of TCI states may be applicable to downlink and/or uplink (e.g., each of the downlink physical channels and/or each of the uplink physical channels). The list of TCI states may be a list of downlink TCI states, and the absence of a (separate) list of uplink TCI states may imply that the list of downlink TCI states is applicable to both the downlink and uplink (physical channels). The list of downlink TCI states may be referred to as a list of joint-downlink TCI states.

In another example, one or more RRC messages 1714 may comprise separate lists of TCI states for downlink and uplink. For example, the list of TCI states may comprise a list of downlink TCI states and a list of uplink TCI states. In this example, the list of downlink TCI states are applicable to the downlink (physical channels) and the list of uplink TCI states are applicable to the uplink (physical channels). Additionally or alternatively, one or more RRC messages 1714 may comprise a parameter set to joint or separate to indicate that the list of TCI states is (e.g., jointly) applicable for both downlink and uplink or that separate lists are configured for downlink and uplink. It should be noted that a list of TCI states applicable to downlink may be referred to as a list of joint-downlink TCI states even when a separate list of uplink TCI states are configured.

As another example, one or more RRC messages 1714 may indicate one (e.g., a single) TCI state instead of a plurality of TCI states. In response to one or more RRC messages 1714 indicating one TCI state, wireless device 1740 may (e.g., start to) apply the TCI state (e.g., without additional signaling via MAC CE and/or DCI).

Similar to the TCI states indicated by one or more RRC messages 1702 of FIG. 17A, the plurality of TCI states indicated by one or more RRC messages 1714 may be referred to as configured TCI states or RRC-configured TCI states.

As illustrated in FIG. 17B, wireless device 1740 receives a MAC CE 1716 indicating activation of one or more TCI states (e.g., of the plurality of TCI states configured by one or more RRC messages 1714). For example, MAC CE 1716 may indicate TCI state IDs of a plurality of TCI states for activation. As an example, MAC CE 1716 may comprise a field indicating a TCI state ID for each of the one or more TCI states activated by MAC CE 1716. The field may be referred to as a TCI state ID field. The TCI states activated by MAC CE 1716 may be referred to as activated TCI states.

MAC CE 1716 may map (e.g., associate) TCI state ID fields, in MAC CE 1716, to a codepoint value corresponding to one or more TCI states (a TCI codepoint or TCI state codepoint). MAC CE 1716 may comprise a field indicating whether a TCI codepoint, corresponding to the field, is associated with (e.g., is mapped to) a single TCI state ID or multiple TCI state IDs (e.g., two TCI state IDs). For example, a first value (e.g., 0) of the field may indicate that a (single) TCI codepoint (e.g., 00) is mapped to a (single) TCI state ID field (e.g., the TCI codepoint is mapped to one TCI state ID indicated by one TCI state ID field MAC CE 1716). A second value (e.g., 1) of the field may indicate that a (single) TCI codepoint (e.g., 00) is mapped to multiple TCI state ID fields (e.g., the TCI codepoint is mapped to two TCI state IDs indicated by two consecutive TCI state ID fields of MAC CE 1716). The ordinal position of the field in MAC CE 1716 may correspond to a TCI state ID field is the same relative ordinal position (e.g., the last field may correspond to the last TCI state ID field in MAC CE 1716). The field may be referred to as a TCI codepoint mapping field.

MAC CE 1716 may comprise a field indicating whether a TCI state ID, indicated by a TCI state ID field (e.g., in the same octet as the field), is an ID of a joint-downlink TCI state or an uplink TCI state. This may enable wireless device 1740 to identify the TCI state ID from a list of joint-downlink TCI states and a list of uplink TCI states (e.g., in case the same value of a TCI state ID is used by a TCI state in the joint-downlink TCI states and another TCI state in the list of uplink TCI states). The field indicating whether a TCI state ID is an ID of a joint-downlink TCI state or an uplink TCI state may be referred to as a D/U field (where D refers to TCI states applicable to downlink or to both downlink and uplink, and U refers to TCI states applicable to uplink).

There may be two signaling mechanisms to indicate which TCI state that wireless device 1740 is to apply among the TCI states configured by one or more RRC messages 1714. In a first signaling mechanism, MAC CE 1716 may indicate to (start to) apply (e.g., and/or indicate activation of) a TCI state (e.g., a single TCI state) (without any additional signaling by, e.g., a DCI). Additionally or alternatively, MAC CE 1716 may indicate to apply multiple TCI states in the first mechanism by indicating a mapping for a single TCI codepoint. For example, based on the field indicating that a TCI codepoint, corresponding to the field, is associated with multiple TCI state IDs (e.g., two TCI state IDs), MAC CE 1716 may indicate to (start to) apply multiple TCI states (without any additional signaling by, e.g., a DCI).

In a second signaling mechanism, MAC CE 1716 indicates activation of a plurality of TCI states. The plurality of TCI states are mapped, by MAC CE 1716, to a plurality of TCI codepoints and a DCI indicates one of the TCI codepoints for wireless device 1740 to apply. For example, as illustrated in FIG. 17B, wireless device 1740 receives a DCI 1718. DCI 1718 indicates a TCI state (e.g., a TCI codepoint) among the TCI states activated by MAC CE 1716. For example, DCI 1718 may comprise a field indicating a TCI codepoint. The field may be referred to as a TCI field or a TCI state field. The value of the TCI field may indicate the TCI state (e.g., the TCI codepoint value associated with the TCI state). Based on (e.g., the TCI field of) DCI 1718 indicating the TCI state among the activated TCI states, wireless device 1740 applies (starts to apply) the TCI state.

A TCI state indicated by MAC CE 1716 and/or DCI 1718 may be referred to as an indicated TCI state or an updated TCI state. The indicating by MAC CE 1716 and/or DCI 1718 may be referred to as updating the TCI state (e.g., the indicated TCI state or the current TCI state). For example, by indicating a TCI state for downlink and/or uplink, MAC CE 1716 (in the first mechanism) may be said to update the (indicated) TCI state. Similarly, when MAC CE 1716 indicates activation of a plurality of TCI states and DCI 1718 indicates a TCI state for downlink and/or uplink, DCI 1718 may be said to update the (indicated) TCI state.

After the TCI state is indicated by MAC CE 1716 and/or DCI 1718, wireless device 1740 applies the TCI state to receive downlink receptions and/or transmit uplink transmissions. The (indicated) TCI state may remain as the TCI state that wireless device 1740 applies to (subsequent) downlink receptions and uplink receptions (e.g., until another TCI state is indicated, or updated, by a subsequent MAC CE and/or DCI).

For example, returning to FIG. 17B, wireless device 1740 receives a DCI 1722 from base station 1760 (e.g., after the TCI state indicated by MAC CE 1716 and/or DCI 1718 is applied). DCI 1722 schedules one or more downlink transmissions 1724 and/or schedules (or triggers) one or more uplink transmissions 1726. Wireless device 1740 receives one or more downlink transmissions 1724 based on the TCI state indicated by MAC CE 1716 and/or DCI 1718. Similarly, wireless device 1740 transmits one or more uplink transmissions 1726 based on the TCI state indicated by MAC CE 1716 and/or DCI 1718.

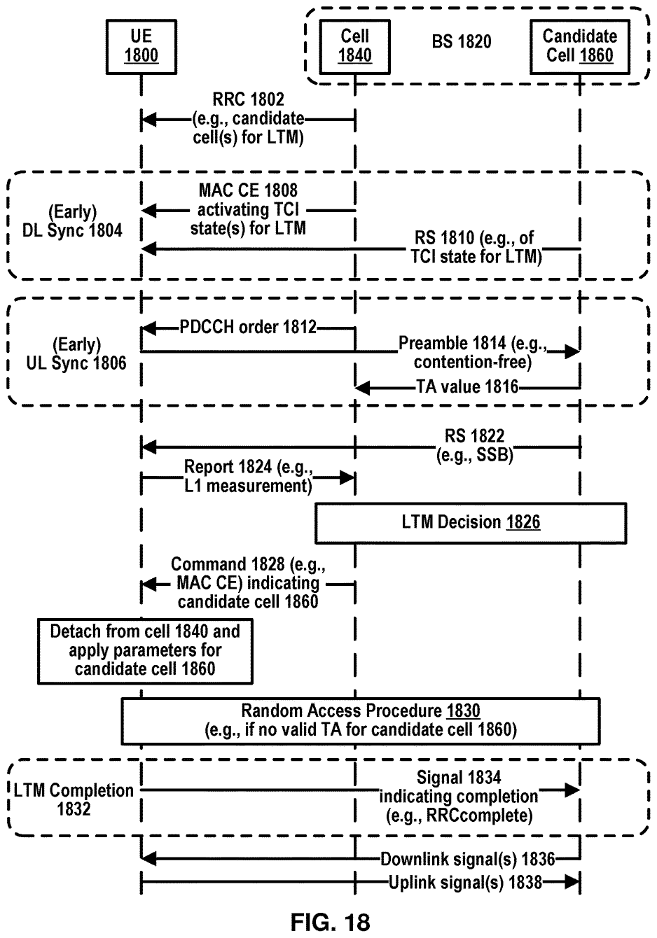

FIG. 18 illustrates an example procedure of a wireless device 1800 performing a procedure for layer-1/layer-2 triggered mobility (LTM) with a base station 1820. The procedure for LTM may be referred to as a lower-layer triggered mobility, a lower-layer triggered mobility procedure, or an LTM procedure.

During the LTM procedure, a serving cell (e.g., a primary cell, such as a PCell or a PSCell) of wireless device 1800 is switched from a cell (e.g., a current serving cell) to a candidate cell (e.g., a non-serving cell, such as an SCell or a neighbor cell) for LTM (e.g., a candidate cell among one or more candidate cells for LTM) based on measurements of the candidate cell and/or the serving cell.

As illustrated in FIG. 18, wireless device 1800 performs the LTM procedure for an LTM cell switch (of the serving cell of wireless device 1800) from a cell 1840 to a candidate cell 1860 of base station 1820. The switching of the serving cell of wireless device 1800 based on the LTM procedure may be referred to as an LTM cell switch, a cell switch, an LTM serving cell switch, a serving cell switch, LTM cell switching, cell switching, LTM serving cell switching, or serving cell switching.

Cell 1840 is the current serving cell of wireless device 1800 (e.g., wireless device 1800 is in RRC connected state with, and/or camped on, cell 1840). Cell 1840 may be a primary cell of wireless device 1800, such as a PCell or a PSCell. In the present disclosure, the cell of a wireless device performing the LTM procedure (such as cell 1840) may be referred to as a source cell, a current serving cell, or a serving cell of the wireless device.

In the LTM procedure as illustrated in FIG. 18, the network (e.g., base station 1820) may indicate for (e.g., command or instruct) wireless device 1800 to perform an LTM cell switch to a cell among a plurality of candidate cells, such as candidate cell 1860 as illustrated in FIG. 18. Candidate cell 1860 may be another serving cell of wireless device 1800, such as an SCell, or candidate cell 1860 may be a non-serving cell, such as a neighbor cell (e.g., a neighbor cell that is not a serving cell) of wireless device 1800.

By performing the LTM cell switch, wireless device 1800 changes the current serving cell from, e.g., cell 1840 to candidate cell 1860. In the present disclosure, a cell (such as candidate cell 1860) that a wireless device performs the LTM cell switch to (e.g., from a source cell or a current serving cell, such as cell 1840, and/or changes a serving cell to) may be referred to as a candidate cell, an LTM candidate cell, a target cell, or an LTM target cell.

As illustrated in FIG. 18, cell 1840 and candidate cell 1860 are cells of base station 1820. As one example, an LTM cell switch may be performed between different cells of the same base station. Before the LTM cell switch, signaling between wireless device 1800 and base station 1820 occur on (e.g., via) cell 1840 (e.g., as cell 1840 is the (current) serving cell of wireless device 1800 before the LTM cell switch is completed). After the LTM cell switch, signaling between wireless device 1800 and base station 1820 occur on (e.g., via) candidate cell 1860 (e.g., as candidate cell 1860 becomes a (new) serving cell of wireless device 1800, such as a primary cell of wireless device 1800).

As mentioned above, cell 1840 and candidate cell 1860 are cells of (e.g., the same) base station 1820 in FIG. 18. As an example, cell 1840 and candidate cell 1860 may be connected with the same central unit (CU) of base station 1820 and different distributed units (DUs) of base station 1820. This may be referred to as intra-CU LTM or inter-DU LTM. As another example, cell 1840 and candidate cell 1860 may be connected with the same DU of base station 1820 (and the same CU of base station 1820). This may be referred to as intra-DU LTM.

Although FIG. 18 illustrates an example of an LTM procedure in which cell 1840 and candidate cell 1860 are among cells of the same base station (base station 1820), the present disclosure is not particularly limited to performing LTM between cells of a single base station (e.g., the same CU). Instead, cells of different base stations (e.g., via different DUs and CUs, which may be referred to as inter-CU LTM) are also within the scope of the present disclosure.

Returning to FIG. 18, wireless device 1800 receives one or more RRC messages 1802 on cell 1840. One or more RRC messages 1802 may indicate one or more configuration parameters for LTM. For example, one or more RRC messages 1802 may indicate one or more candidate cells for LTM. The one or more candidate cells, of one or more RRC messages 1802, comprise candidate cell 1860.

As an example, one or more RRC messages 1802 may indicate a candidate LTM configuration for each of the one or more candidate cells. Using candidate cell 1860 as an example, one or more RRC messages 1802 may comprise an LTM candidate configuration for candidate cell 1860. The LTM candidate configuration for candidate cell 1860 may indicate, or comprise, an identifier (ID) of the LTM candidate configuration. The ID of the LTM candidate configuration may be referred to as an LTM candidate configuration ID or a candidate cell ID.

The LTM candidate configuration, of candidate cell 1860, may indicate an ID of candidate cell 1860. For example, the LTM candidate configuration, of candidate cell 1860, may comprise the ID of candidate cell 1860. As an example, the ID of candidate cell 1860 may be a physical cell ID (PCI) of candidate cell 1860.

The LTM candidate configuration, of candidate cell 1860, may indicate one or more parameters of an RRC message, such as an RRC reconfiguration message, to configure the LTM candidate configuration of candidate cell 1860.

The LTM candidate configuration, of candidate cell 1860, may indicate one or more parameters of a configuration for performing (early) uplink synchronization on candidate cell 1860 (e.g., before wireless device 1800 receives a command indicating to perform the LTM cell switch to candidate cell 1860). The LTM candidate configuration may indicate an (early) uplink synchronization configuration for a normal uplink (NUL) carrier of candidate cell 1860 and/or an (early) uplink synchronization configuration for a supplementary uplink (SUL) carrier of candidate cell 1860. In other words, there may be separate (early) uplink synchronization configurations for the NUL carrier and SUL carrier of candidate cell 1860.

One or more RRC messages 1802 may indicate a reference signal for performing synchronization (e.g., time and/or frequency synchronization) for each of the one or more candidate cells. As an example, the reference signal for performing synchronization may be an SSB (which may be referred to as a SS/PBCH block).

For example, the LTM candidate configuration, of candidate cell 1860, may indicate a reference signal, of candidate cell 1860, for performing synchronization. Using an SSB as an example of the reference signal for performing synchronization, the LTM candidate configuration, of candidate cell 1860, may indicate one or more parameters of an SSB of candidate cell 1860. For the SSB of candidate cell 1860, the one or more parameters may comprise at least one of: a frequency of the SSB, a subcarrier spacing of the SSB, a periodicity of the SSB, a position of the SSB (e.g., in a bitmap of an SSB set), and/or a power of the SSB.

One or more RRC messages 1802 may indicate one or more reference signals for measurement reports of the one or more candidate cells for LTM. The one or more reference signals for measurement reports may be indicated in the LTM candidate configuration for each of the one or more candidate cells.

For example, one or more RRC messages 1802, may indicate one or more reference signals, of candidate cell 1860, for reporting measurement reports. The measurement reports may be CSI reports, such as a radio link quality of the one or more reference signals. The radio link quality reported in the CSI reports may be, e.g., an RSRP, a layer-1 RSRP, and/or an SINR of each of the one or more reference signals.

One or more RRC messages 1802 may indicate one or more resources (radio resources) of the one or more reference signals for reporting measurement reports of candidate cell 1860. The one or more resources of the one or more reference signals may be referred to as one or more reference signal resources. The one or more reference signals (e.g., indicated by the one or more resources) may be one or more SSBs and/or one or more CSI-RSs of candidate cell 1860. One or more RRC messages 1802 may indicate a reference signal resource configuration for performing the measurement reports of candidate cell 1860. The reference signal resource configuration may be referred to as an LTM RS resource configuration or an LTM CSI resource configuration. One or more RRC messages 1802 may indicate an ID of the reference signal resource configuration.

One or more RRC messages 1802 may, for each of the one or more candidate cells, indicate a report configuration for measurement reports of the one or more reference signals (e.g., indicated by the LTM candidate configuration). For example, one or more RRC messages 1802 may indicate a report configuration for measurement reports of candidate cell 1860. The report configuration may be referred to as an LTM RS report configuration or an LTM CSI report configuration. The report configuration may indicate a report configuration type of CSI reporting, such as periodic, semipersistent, or aperiodic. The report configuration may indicate an ID of a reference signal resource configuration, which identifies the reference signals to be reported based on the report configuration.

As discussed above, the measurement reports may be CSI reports, such as a radio link quality of the one or more reference signals. Using a layer-1 measurement (e.g., layer-1 RSRP as an example, the report configuration may indicate contents for the report. For example, the report configuration may indicate that the contents of the report comprise at least one of: a number of cells to be reported (e.g., 1, 2, 3, or 4 cells), a number of reference signals to be reported (e.g., 1, 2, 3, or 4 reference signals), and whether a layer-1 measurement of the current serving cell (e.g., cell 1840) is to be included.

One or more RRC messages 1802 may indicate candidate TCI states, for LTM, of the one or more candidate cells. For example, one or more RRC messages 1802 may comprise one or more configuration parameters of the candidate TCI states, for LTM, of the one or more candidate cells. The one or more configuration parameters, of one or more RRC messages 1802, may comprise a list of candidate TCI states for each candidate cell among the one or more candidate cells indicated by one or more RRC messages 1802. Each list of candidate TCI states may comprise identifiers (IDs) of the one or more candidate TCI states of a (respective) candidate cell. An ID of a candidate TCI state may be referred to as a candidate TCI state ID or a TCI state ID of a candidate TCI state.

For example, one or more RRC messages 1802 may indicate, for candidate cell 1860, a list of candidate TCI states for LTM. The list of candidate TCI states may be a list of TCI states applicable to downlink (e.g., downlink receptions), uplink (e.g., uplink transmissions), or both downlink and uplink (for LTM) on candidate cell 1860.

In an example, one or more RRC messages 1802 may indicate separate lists of candidate TCI states, of candidate cell 1860, for LTM. The separate lists of candidate TCI states may comprise a list of candidate TCI states applicable to downlink on candidate cell 1860 and a (separate) list of candidate TCI states applicable to uplink on candidate cell 1860. A list of candidate TCI states applicable to downlink and uplink on candidate cell 1860 may be referred to as a list of joint-downlink TCI states. The lists of TCI states are similar to the lists of TCI states discussed above in FIG. 17B (e.g., via one or more RRC messages 1714).

One or more RRC messages 1802 may indicate a parameter with a value (e.g., set to joint or separate) that indicates whether a list or separate lists are provided for the candidate TCI states. The parameter may be referred to as a unified TCI state type parameter. Based on being set to joint, the unified TCI state type parameter indicates that a list of candidate TCI states are (jointly) applicable to downlink and uplink on candidate cell 1860. Based on being set to separate, the unified TCI state type parameter indicates that a list of candidate TCI states is applicable to downlink (e.g., a list of joint-DL TCI states) and that a list of candidate TCI states is applicable to uplink (e.g., a list of uplink TCI states).

Each candidate TCI state may be associated with (e.g., identified by) an ID (e.g., a candidate TCI state ID). For example, each candidate TCI state may be identified by an ID configured by one or more RRC messages 1802 (e.g., via the list of candidate TCI states indicated by one or more RRC messages 1802).

Each candidate TCI state may indicate one or more reference signals. The one or more reference signals, indicated by the candidate TCI state, may be used for determining channel estimation properties on candidate cell 1860. For example, a reference signal among the one or more reference signals may be for determining spatial domain parameters, such as for a spatial domain filter (uplink, such as an uplink spatial domain transmission filter or uplink spatial domain filter, and/or downlink, such as a downlink spatial domain reception filter or a downlink spatial domain filter) and/or quasi co-location relationship of the reference signal with antenna ports (e.g., DMRS antenna ports).

The candidate TCI state may indicate a QCL type of each of the one or more reference signals (e.g., QCL Type-A, QCL Type-B, QCL Type-C, and QCL Type-D) as discussed above in connection with FIGS. 17A and 17B (via one or more RRC messages 1702 and/or one or more RRC messages 1714). The one or more reference signals, indicated by the candidate TCI state, may comprise one or more SSBs and/or one or more CSI-RSs. The candidate TCI state may indicate an index for each of the one or more reference signals. The candidate TCI state may indicate a pathloss reference signal for candidate cell 1860. For example, candidate TCI state comprise an ID of a pathloss reference signal for candidate cell 1860.

As an example, the candidate TCI state may indicate two reference signals. The candidate TCI state may indicate a QCL type of the first reference signal is for spatial domain parameters (e.g., QCL Type-D). The candidate TCI state may indicate an index of an SSB for the first reference signal (or, alternatively, an index of a CSI-RS for the first reference signal).

The candidate TCI state may indicate a QCL type of the second reference signal is for other channel estimation parameters (e.g., QCL Type-A). The candidate TCI state may indicate an index of an SSB for the second reference signal (or, alternatively, an index of a CSI-RS for the second reference signal). Although the candidate TCI state may indicate two reference signals, the second reference signal is optional and may not be indicated by the candidate TCI state (e.g., the candidate TCI state may indicate only the first reference signal).

For separate candidate TCI states for downlink and uplink on candidate cell 1860, one or more RRC messages 1802 may indicate an uplink candidate TCI state. The uplink candidate TCI state may, for example, indicate one reference signal. Unlike the candidate TCI state above (e.g., applicable to downlink and uplink or downlink on candidate cell 1860), the uplink candidate TCI state may not (explicitly) indicate the QCL type of reference signal. Instead, it may be assumed that the reference signal is to be used by wireless device 1800 for an uplink spatial (transmission) filter (similar to QCL-type D). Like the candidate TCI state above, the uplink candidate TCI state may indicate an ID of the uplink candidate TCI state, an index of the reference signal indicated by the uplink candidate TCI state (e.g., an SSB index or an index of a CSI-RS on candidate cell 1860), and/or an ID of a pathloss reference signal for candidate cell 1860.

The candidate TCI state may indicate a group of cells that the same timing advance is applied to by wireless device 1800. The group of cells may be referred to as a timing advance group (TAG). For example, the TCI state may comprise a field (e.g., tag-Id-ptr) that indicates the TAG that is associated with the candidate TCI state. A first value of the field may indicate that the candidate TCI state is applied to a first TAG (e.g., configured by one or more RRC messages 1802), and a second value of the field may indicate that the candidate TCI state is applied to a second TAG (e.g., configured by one or more RRC messages 1802).

The candidate TCI state may indicate a set of power control parameters for one or more uplink signals (e.g., PUCCH transmissions, PUSCH transmissions, and/or SRS transmissions) that are to be transmitted based on the candidate TCI state. For example, the candidate TCI state may comprise a field (e.g., ul-powerControl, ul-powerControlId) that indicates a set of power control parameters from among sets of power control parameters (e.g., configured by one or more RRC messages 1802). The candidate TCI state may not indicate a set (e.g., any set) of power control parameters (e.g., the field may not be configured in the TCI state) based on the uplink BWP of candidate cell 1860 (e.g., a first-active uplink BWP of candidate cell 1860) being configured (e.g., by one or more RRC messages 1802) with a parameter that indicates which set of the sets of power control parameters is to be used.

In the present disclosure, a candidate TCI state refers to a TCI state, of candidate cell 1860, to be used for LTM. The candidate TCI state may be referred to as a TCI state for LTM, an LTM TCI state, or an LTM candidate TCI state.

After wireless device 1800 receives one or more RRC messages 1802, wireless device 1800 may transmit (to base station 1820 and/or on cell 1840), an RRC message indicating that parameters indicated by one or more RRC messages 1802 are (successfully) received (and/or stored). The RRC message may be RRC reconfiguration completion message (e.g., such as RRCReconfigurationComplete).

The RRC message may comprise a parameter that indicates an ID of candidate cell 1860 (e.g., from one or more RRC messages 1802). For example, the ID of candidate cell 1860 may be the ID of the LTM candidate configuration of candidate cell 1860 and/or the PCI of candidate cell 1960. The parameter may be referred to as an applied LTM candidate ID and a value of the applied LTM candidate ID may be the identifier of the candidate cell 1860.

In the LTM procedure, there are two optional synchronization mechanisms that may be used to enable wireless device 1800 to synchronize with candidate cell 1860 before performing an LTM cell switch from cell 1840 to candidate cell 1860 (e.g., before receiving a command from base station 1820 indicating to switch to candidate cell 1860). These optional synchronization mechanisms may reduce the time for wireless device 1800 to perform the LTM cell switch to candidate cell 1860.

The optional synchronization mechanisms include a mechanism for downlink synchronization with candidate cell 1860 and a mechanism for uplink synchronization with candidate cell 1860. The optional synchronization mechanisms may be, e.g., referred to individually as early downlink synchronization and early uplink synchronization, respectively. Alternatively, the optional synchronization mechanisms may be collectively referred to as early synchronization or, early cell synchronization, or synchronization before an LTM cell switch.

It should be understood that both early downlink synchronization and early uplink synchronization are optional, such that one of, none of, or both of early downlink synchronization and early uplink synchronization may be performed in an LTM procedure. The network (e.g., base station 1820) may indicate (e.g., request, order, command, or transmit a signal indicating) to wireless device 1800 to perform early downlink synchronization and/or early uplink synchronization.

As an example, FIG. 18 illustrates that, during LTM procedure, wireless device 1800 performs both an early downlink synchronization 1804 with candidate cell 1860 and an early uplink synchronization 1806 with candidate cell 1860.

In early downlink synchronization 1804, wireless device 1800 receives a MAC CE 1808 (e.g., from base station 1820 and/or on cell 1840) indicating, for candidate cell 1860, activation of one or more candidate TCI states for LTM. The one or more candidate TCI states activated by MAC CE 1808 may be from among (e.g., the list of) the candidate TCI states indicated (e.g., configured by) one or more RRC messages 1802. MAC CE 1808 may be referred to as a candidate cell TCI states activation/deactivation MAC CE.

Although candidate cell 1860 is not a current serving cell (e.g., not the primary cell, such as a PCell or a PSCell) in this example, wireless device 1800 may activate the one or more candidate TCI states of candidate cell 1860 during early downlink synchronization 1804. For example, the one or more candidate TCI states of candidate cell 1860, indicated by MAC CE 1808, may be activated while other TCI states of cell 1840 (e.g., the current serving cell, or primary cell, of wireless device 1800) are (also) activated (e.g., based on the procedures illustrated in FIGS. 17A and 17B). This may enable wireless device 1800 to reduce the time to perform the LTM cell switch to candidate cell 1860 (e.g., in response to receiving a command from base station 1820 to perform an LTM cell switch to candidate cell 1860).

MAC CE 1808 indicates activation of one or more candidate TCI states, of candidate cell 1860, for LTM. As an example of indicating the candidate cell 1860, MAC CE 1808 may indicate a candidate cell ID of candidate cell 1860 (e.g., an ID of an LTM candidate configuration of candidate cell 1860 configured by one or more RRC messages 1802). For example, MAC CE 1808 may comprise a field (e.g., in an octet) that indicates the candidate cell ID of candidate cell 1860 (e.g., a value of the field corresponds to the candidate cell ID of candidate cell 1860).

As an example of indicating activation of the one or more candidate TCI states, MAC CE 1808 may indicate one or more candidate TCI state IDs. The one or more candidate TCI state IDs may be from (e.g. the list) of candidate TCI states (e.g., list of candidate TCI state IDs) indicated by one or more RRC messages 1802. For example, MAC CE 1808 may comprise one or more fields indicating one or more candidate TCI state IDs of the one or more candidate TCI states.

Each octet of MAC CE 1808 may comprise a field indicating a candidate TCI state ID. This field may be referred to as a TCI state ID field. The value of the TCI state ID field may correspond to one or more candidate TCI state IDs. MAC CE 1808 may map (e.g., associate) each TCI state ID field to a TCI state codepoint.

The ordinal position of each TCI state ID field in MAC CE 1808 may correspond to a value of a TCI state codepoint. For example, the TCI state ID field that is first in MAC CE 1808 (e.g., listed first, occurs first, in an earliest octet, or in an octet occurring first among the octets of MAC CE 1808 indicating TCI state IDs) is mapped to, e.g., a lowest TCI codepoint value (e.g., a codepoint value of 00), and the TCI state ID field that is last in MAC CE 1808 (e.g., listed last, occurs last, in last octet, or in an octet occurring last among the octets of MAC CE 1808 indicating TCI state IDs) is mapped to, e.g., a highest TCI codepoint value (e.g., a codepoint value of 11).

MAC CE 1808 may comprise a field indicating whether the TCI state codepoint is associated with (e.g., is mapped to) a single candidate TCI state ID or multiple candidate TCI state IDs (e.g., two candidate TCI state IDs). The field indicating whether a TCI state codepoint is associated with a single candidate TCI state ID in MAC CE 1808 or multiple candidate TCI state IDs in MAC CE 1808 may be referred to as a Pᵢ field, a TCI codepoint mapping field, or a field indicating a single-or-multiple mapping of candidate TCI state IDs to codepoints.

As an example of the Pᵢ field of MAC CE 1808, a first value (e.g., 0) of the field may indicate that a (single) TCI state codepoint is mapped to a TCI state ID field (a single TCI state field). This may indicate, e.g., that only the last candidate TCI state ID is mapped to the highest TCI codepoint value. A second value (e.g., 1) of the field may indicate that a (single) TCI state codepoint is mapped to multiple TCI state ID fields. This may indicate, e.g., that the second-to-last (penultimate) candidate TCI state ID and the last candidate TCI state ID are (both) mapped to the highest TCI codepoint value.

The ordinal position of the Pᵢ field in MAC CE 1808 may correspond to a TCI state ID field is the same ordinal position. For example, a Pᵢ field that occurs first (e.g., is positioned first, is listed first, or is earliest) in MAC CE 1808 corresponds to a TCI state ID field that occurs first (e.g., is positioned first, is listed first, or is earliest) in MAC CE 1808 among TCI state IDs of MAC CE 1808. A Pᵢ field that occurs last (e.g., is positioned last, is listed last, or is latest) in MAC CE 1808 corresponds to a TCI state ID field that occurs last (e.g., is positioned last, is listed last, or is latest) in MAC CE 1808 among TCI state IDs of MAC CE 1808.

MAC CE 1808 may (also) comprise a field indicating whether a candidate TCI state ID is an ID of a joint-downlink candidate TCI state or an uplink candidate TCI state. The field indicating whether a candidate TCI state ID is an ID of a (joint-downlink) candidate TCI state or an uplink candidate TCI state may be referred to as a D/U field (where D refers to candidate TCI states applicable to downlink or jointly to uplink and downlink, and U refers to candidate TCI states applicable to uplink).

For example, a first value (e.g., 0) of the D/U field may indicate that the candidate TCI state ID (e.g., in the same octet as the field) is applicable to downlink (on candidate cell 1860) and/or downlink and uplink (on candidate cell 1860). A second value (e.g., 1) of the D/U field may indicate that the candidate TCI state ID (e.g., in the same octet as the field) is applicable to uplink (on candidate cell 1860). This may enable wireless device 1800 to determine which candidate TCI state the candidate TCI state ID identifies (e.g., a candidate TCI state ID from the list of candidate TCI states for uplink and/or from the list of candidate TCI states for downlink and uplink).

Returning to FIG. 18, after receiving MAC CE 1808 and during early downlink synchronization 1804, wireless device 1800 receives a reference signal 1810 from candidate cell 1860. Reference signal 1810 is indicated by a candidate TCI state activated by MAC CE 1808. Wireless device 1800 performs downlink synchronization using reference signal 1810 (e.g., performs measurements and/or channel estimation based on reference signal 1810).

For ease of discussion, FIG. 18 illustrates candidate TCI states of one candidate cell (candidate cell 1860) being activated with a single MAC CE (e.g., MAC CE 1808). However, it should be understood that wireless device 1800 may receive (from base station 1820 and/or on cell 1840) a (separate) MAC CE (based on MAC CE 1808) for each candidate cell (e.g., to perform early downlink synchronization 1804).

There are two approaches to early uplink synchronization. Both approaches are used for acquiring a timing advance to be (potentially) used for adjusting uplink transmission timing on candidate cell 1860 (e.g., to adjust uplink transmission, in advance, relative to downlink transmissions in order to align uplink and downlink timing at base station 1820, which may be done by all wireless devices on candidate cell 1860).

In a first approach to early uplink synchronization, wireless device 1800 estimates (acquires) the timing advance value by performing measurements of downlink signals from candidate cell 1860. The first approach may be used based on a UE capability of wireless device 1800.

For example, one or more RRC messages 1802 may comprise a parameter for candidate cell 1860 (e.g., in the LTM candidate configuration for candidate cell 1860) indicating to (e.g., enabling) wireless device 1800 to perform measurements for wireless device 1800 to estimate (acquire) the timing advance value of candidate cell 1860. The parameter may be referred to as a UE-measured TA parameter. Wireless device 1800 may perform the measurements to estimate (acquire) the timing advance value of candidate cell 1860 in response to one or more RRC messages 1802 indicating the parameter and the wireless device 1800 supporting a UE capability (e.g., for estimating the timing advance by measurement).

In a second approach to early uplink synchronization, the network (e.g., base station 1820) may estimate the timing advance value based on uplink signals received from wireless device 1800 on the candidate cell 1860. The second approach may be used, e.g., based on wireless device 1800 not having the UE capability for estimating (e.g., by measurement) timing advance on candidate cell 1860, one or more RRC messages 1802 not comprising the UE-measured TA parameter, and/or based on a timing advance no longer being valid (e.g., a timing advance value received via one or more messages is no longer valid and/or a timing advance value estimated by wireless device 1800, by measurement, is no longer valid). Additionally or alternatively, the second approach may be used in response to wireless device 1800 receiving a signal to perform the second approach, such as a PDCCH order. That is, the second approach may be used even if wireless device 1800 has a (valid) timing advance value.

Returning to FIG. 18, early uplink synchronization 1806 is an example of the second approach in which the network (e.g., base station 1820) estimates the timing advance value based on uplink signals received from wireless device 1800 on the candidate cell 1860. As illustrated, wireless device 1800 receives a PDCCH order 1812 (e.g., from base station 1820 and/or on cell 1840) indicating candidate cell 1860.

After receiving PDCCH order 1812, wireless device 1800 transmits a preamble 1814 to candidate cell 1860. Preamble 1814 may be contention free. For example, one or more RRC messages 1802 may comprise physical random-access channel (PRACH) parameters (e.g., PRACH resources) for candidate cell 1860. The PRACH parameters of candidate cell 1860 may be indicated by an uplink synchronization configuration (of one or more RRC messages 1802 discussed above). The uplink synchronization configuration may be referred to as an early uplink synchronization configuration. The (early) uplink synchronization configuration may be for candidate cell 1860 and/or indicated by an LTM candidate configuration of candidate cell 1860. Wireless device 1800 may transmit preamble 1814 based on the PRACH parameters (e.g., via a PRACH resource) of candidate cell 1860. Preamble 1814 may be referred to as a PRACH transmission.

After receiving preamble 1814, base station 1820 determines (estimates) a timing advance value 1816 for wireless device 1800. For early uplink synchronization 1806, wireless device 1800 does not monitor for the timing advance value 1816 after transmitting preamble 1814. For example, based on a typical random-access procedure (not for LTM), wireless device 1800 may monitor for a random-access response (RAR) comprising timing advance value 1816.

On the other hand, in early uplink synchronization 1806, base station 1820 may send (e.g., from candidate cell 1860) timing advance value 1816 to cell 1840 (the current serving cell of wireless device 1800, such as to the DU associated with cell 1840). Base station 1820 may transmit timing advance value 1816 to wireless device 1800 on cell 1860 in response to base station 1820 determining to trigger wireless device 1800 to perform an LTM cell switch to candidate cell 1860 (e.g., timing advance value 1816 may be indicated by a command that indicates to perform an LTM cell switch to candidate cell 1860).

As explained above, downlink synchronization 1804 with candidate cell 1860 and uplink synchronization 1806 with candidate cell 1860 are optional and wireless device 1800 may perform one of, both of, or none of the (early) synchronization procedures (before performing LTM cell switching to candidate cell 1860). When wireless device 1800 performs one of, both of, or none of the (early) synchronization procedures, wireless device 1800 may perform the (early) synchronization procedures based on being triggered by base station 1820 (e.g., by MAC CE 1808 for early downlink synchronization 1804 and/or PDCCH order 1812 for early uplink synchronization 1806).

The example LTM procedure illustrated in FIG. 18 proceeds to execution of the LTM cell switch to candidate cell 1860. As illustrated in FIG. 18, the wireless device 1800 receives (e.g., from base station 1820 and/or candidate cell 1860) a reference signal 1822 for performing measurements for LTM. As an example, one or more RRC messages 1802 may indicate, for candidate cell 1860, one or more resources for reference signal 1822 (e.g., one or more reference signal resources). Additionally or alternatively, one or more RRC messages 1802 may indicate, for candidate cell 1860, one or more parameters for reporting a (e.g., layer-1) measurement report of candidate cell 1860 based on measurements of reference signal 1822. Reference signal 1822 may be an SSB and/or a CSI-RS of candidate cell 1860.

After receiving reference signal 1822, wireless device 1800 transmits a report 1824 based on (e.g., measurements of) reference signal 1822. For example, wireless device 1800 may perform measurements (e.g., layer-1 measurements) on reference signal 1822 (e.g., based on one or more parameters for reporting a measurement report of candidate cell 1860 in one or more RRC messages 1802). Report 1824 may be a type of UCI or a MAC CE. Report 1824 may comprise a field indicating a radio link quality (e.g., a layer-1 RSRP, RSRP, or SINR) of reference signal 1822. Report 1824 may comprise a radio link quality of one or more reference signals of candidate cell 1860. Report 1824 may comprise a radio link quality of one or more reference signals of one or more candidate cells other than candidate cell 1860.

After receiving report 1824, base station 1820 determines to indicate to wireless device 1800 to perform the LTM cell switch (e.g., of the serving cell, such as a primary cell) from cell 1840 to candidate cell 1860. This is illustrated in FIG. 18 as an LTM decision 1826. As an example, LTM decision 1826 may be made on cell 1840 (e.g., by a DU and/or CU of cell 1840).

While base station 1820 may use report 1824 in LTM decision 1826, base station 1820 may use other factors for LTM decision 1826, such as network congestion, reports from other wireless devices for candidate cell 1860, interference with neighbor cells, and/or power considerations. Base station 1820 may use these other factors for LTM decision 1826 in addition to report 1824 or instead of report 1824 for LTM decision 1826 (e.g., even though base station 1820 receives report 1824, base station 1820 may make LTM decision 1826 independently from report 1824).

After base station 1820 makes LTM decision 1826 in FIG. 18 for wireless device 1800 to perform the LTM cell switch to candidate cell 1860, base station 1820 transmits a command 1828 to wireless device 1800 indicating to perform the LTM cell switch to cell 1860. Base station 1820 transmits command 1828 on cell 1840, which is the current serving cell of wireless device 1800, and wireless device 1800 receives command 1828 on cell 1840.

Command 1828 indicates to perform the LTM cell switch to candidate cell 1860 (e.g., to change the serving cell of wireless device 1800 from cell 1840 to candidate cell 1860). As an example, command 1828 may be a MAC CE. Command 1828 may be referred to as a cell switch command, an LTM cell switch command, a MAC CE indicating to perform a LTM cell switch, and/or an LTM cell switch command MAC CE.

As an example of indicating the candidate cell 1860, command 1828 may indicate a configuration for performing an LTM cell switch to candidate cell 1860. For example, command 1828 may comprise a field (e.g., in an octet) that indicates an ID of a configuration (e.g., an LTM candidate configuration, of candidate cell 1860, configured by one or more RRC messages 1802) to apply for the LTM cell switch (and the configuration may indicate the ID of candidate cell 1860, such as a PCI). The field may be referred to as a configuration ID field, a target configuration ID field, a candidate cell ID field, or a candidate cell configuration ID field.

Command 1828 may indicate a timing advance command for candidate cell 1860. For example, command 1828 may comprise a field (e.g., in one or more octets) indicating the timing advance command. The field may be referred to as a timing advance command field. A value of the timing advance command field may indicate an index of a (valid) timing advance value or that no timing advance value is available. The value of the timing advance command may also be referred to as a timing advance value.

As an example of indicating that no timing advance value is available for candidate cell 1860, a predetermined value (e.g., FFF in hexadecimal or all bits of the field being set to 1 in binary), of the timing advance command field, may indicate that no timing advance value is available for candidate cell 1860. The predetermined value of the timing advance command field of command 1828 may indicate (e.g., implicitly) to wireless device 1800 to perform a random-access procedure to candidate cell 1860. Additionally or alternatively, the predetermined value (e.g., FFF or all ones) may indicate for wireless device 1800 to use a timing advance estimated (measured) by wireless device 1800 (e.g., based on the first approach of uplink synchronization 1806). Wireless device 1800 may apply the estimated (measured) timing advance based on the timing advance value indicating that no timing advance value is available in response to (e.g., if, when, or based on) (e.g., determining that) wireless device 1800 successfully measured the timing advance of candidate cell 1860.

As an example of indicating a timing advance value (is available) for candidate cell 1860, a value (e.g., other than the predetermined value, such as an applicable value, a valid value, or a first value), of the timing advance command field, may indicate an index of a timing advance value to be used, by wireless device 1800, to adjust uplink transmissions to candidate cell 1860. Based on the value (e.g., based on the value not being the predetermined value and/or based on the value corresponding to a (valid) timing advance value), wireless device 1800 may not perform (e.g., skip) a random-access procedure to candidate cell 1860. In other words, while performing the LTM cell switch to candidate cell 1860, wireless device 1800 may switch (e.g., the serving cell) from cell 1840 to candidate cell 1860 without performing a random-access procedure (to candidate cell 1860).

Similar to MAC CE 1808, command 1828 may indicate activation of one or more candidate TCI states of candidate cell 1860. For example, command 1828 may indicate one or more candidate TCI state IDs of one or more candidate TCI states of candidate cell 1860. The one or more candidate TCI states may be from (e.g. the list) of candidate TCI states of candidate cell 1860 (e.g., the list of candidate TCI states indicated by one or more RRC messages 1802, such as the list of joint-downlink candidate TCI states and/or the list of uplink candidate TCI states).

Command 1828 may comprise one or more fields indicating one or more candidate TCI state IDs of the one or more candidate TCI states. The one or more fields, indicating one or more candidate TCI state IDs, may comprise a TCI state ID field and an uplink TCI state ID field. The TCI state ID field and the uplink TCI state ID field may be separate fields (e.g., in different octets). The TCI state ID field may refer to a candidate TCI state applicable to downlink on candidate cell 1860 or a candidate TCI state applicable to downlink and uplink on candidate cell 1860.

Unlike MAC CE 1808, command 1828 may not comprise a D/U field. Instead, wireless device 1800 may determine that a TCI state ID indicated by TCI state ID field of command 1828 is for downlink or both downlink and uplink based whether one or more RRC messages 1802 indicate that the unified TCI state type parameter of the list candidate TCI states is set to joint or set to separate. Based on the unified TCI state type parameter being set to joint, the TCI state ID field is applicable to both downlink and uplink on candidate cell 1860. Based on the unified TCI state being set to separate, the TCI state ID field is applicable to downlink on candidate cell 1860.

As explained above, command 1828 may comprise an uplink TCI state ID field that may refer to a candidate TCI state applicable to uplink on candidate cell 1860. The uplink TCI state field may not be included in command 1828. For example, based on the unified TCI state type being set to joint for the list of candidate TCI states for candidate cell 1860, the uplink TCI state ID field may not be present in command 1828. Additionally or alternatively, the uplink TCI state ID field may not be present in command 1828 in response to one or more RRC messages 1802 not indicating a list of uplink candidate TCI states. On the other hand, based on the unified TCI state being set to separate for the list of candidate TCI states for candidate cell 1860, the uplink TCI state ID field may be present in command 1828. Based on the unified TCI state being set to separate, the uplink TCI state ID field is applicable to uplink on candidate cell 1860.

Command 1828 may indicate to perform a contention-free random-access procedure to candidate cell 1860. For example, command 1828 may indicate a random-access preamble index for performing the contention-free random-access procedure to candidate cell 1860. Command 1828 may comprise a field indicating the random-access preamble index. The field may be referred to as a random-access preamble index field. The random-access preamble index may correspond to a contention-free random-access resource for performing the random-access procedure to candidate cell 1860.

As another example that may be included in addition to the random-access preamble index field for indicating to perform the contention-free random-access procedure to candidate cell 1860, command 1828 may comprise a field indicating an index of an SSB for performing the contention-free random-access procedure to candidate cell 1860. The field may be referred to an SSB index field of command 1828. The SSB index field may indicate (an index of) the SSB that the wireless device 1800 is to use for determining a RACH occasion for performing the preamble transmission based on the contention-free random-access resources indicated by the random-access preamble index field.

As another example that may be included in addition to the random-access preamble index field and the SSB index field for indicating to perform the contention-free random-access procedure to candidate cell 1860, command 1828 may comprise a field indicating a PRACH mask index. The PRACH mask index may indicate a subset of RACH occasions to be used (among RACH occasions indicated based on the SSB index field). The field indicating the PRACH mask index may be referred to as a PRACH mask index field.

As another example that may be included in addition to the random-access preamble index field, the SSB index field, and the PRACH mask index field for indicating to perform the contention-free random-access procedure to candidate cell 1860, command 1828 may indicate the uplink carrier to transmit a preamble based on the contention-free random access procedure. For example, a field of command 1828 may indicate whether to transmit the preamble on the normal uplink (NUL) carrier of candidate cell 1860 or the supplementary uplink (SUL) carrier of candidate cell 1860. The field may be referred to as an S/U field. As an example, a first value (e.g., 0) of the S/U field may indicate to use the SUL carrier of candidate cell 1860. A second value (e.g., a value other than 0, such as 1) of the S/U field may indicate to use the NUL carrier of candidate cell 1860. The SUL carrier and the NUL carrier of candidate cell 1860 may be referred to as the SUL and NUL, respectively, of candidate cell 1860.

Returning to FIG. 18, after receiving command 1828, wireless device 1800 performs (e.g., execution of) the LTM cell switch to candidate cell 1860. For example, wireless device 1800 switches the current serving cell (e.g., primary cell, such as a PCell or PSCell) from cell 1840 to candidate cell 1860. Wireless device 1800 detaches from cell 1840 and/or applies parameters of candidate cell 1860, such as the parameters (e.g., of the LTM candidate configuration of candidate cell 1860 and/or the RRC reconfiguration message of candidate cell 1860) indicated by command 1828 and/or one or more RRC messages 1802.

In order to perform the LTM cell switch to candidate cell 1860, wireless device 1800 may perform a random-access procedure 1830 to candidate cell 1860. However, the random-access procedure is optional and may be, e.g., performed based on whether a (valid) timing advance is available to wireless device 1800. Based on random-access procedure 1830 being performed, the LTM procedure may be referred to as RACH-based LTM. Based on random-access procedure 1830 not being performed, the LTM procedure may be referred to as RACH-less LTM.

As an example, wireless device 1800 may determine to perform random-access procedure 1830 to candidate cell 1860 in response to command 1828 indicating that no (valid) timing advance value is available for candidate cell 1860 (e.g., a value of the timing advance command field may be the predetermined value, such as FFF in hexadecimal or all bits being set to 1 in binary).

As another example for performing random-access procedure 1830 (in RACH-based LTM), wireless device 1800 may determine to perform random-access procedure 1830 to candidate cell 1860 based on the UE capability of wireless device 1800 and a validity of the timing advance value determined based on the UE capability. For example, as discussed above with respect to (early) uplink synchronization 1806 (i.e., the first approach), wireless device 1800 may be able to estimate (acquire) the timing advance value of candidate cell 1860 by performing measurements of downlink signals of candidate cell 1860. Based on the wireless device 1800 supporting the UE capability and the timing advance value not being available (e.g., not valid, no longer valid), wireless device 1800 may determine to perform random-access procedure 1830. In other words, even after (e.g., successfully) estimating the timing advance value of candidate cell 1860, wireless device 1800 may determine to perform random-access procedures 1830 in response to the timing advance value no longer being available (or valid).

On the other hand, wireless device may (e.g., determine to) not perform (e.g., skip) random-access procedure 1830. As an example of RACH-less LTM, wireless device 1800 may determine to not perform random-access procedure 1830 to candidate cell 1860 in response to command 1828 indicating that a (valid) timing advance value (e.g., is available) for candidate cell 1860 (e.g., a value, other than the predetermined value, of the timing advance command field as discussed above). Wireless device 1800 may apply the timing advance value indicated by command 1828 (e.g., the value of the timing advance command field) and not perform random-access procedure 1830 (e.g., instead of performing random-access procedure 1830).

As another example of RACH-less LTM, wireless device 1800 may determine to not perform random-access procedure 1830 to candidate cell 1860 based on the UE capability of wireless device 1800. For example, as discussed above with respect to (early) uplink synchronization 1806 (i.e., the first approach), wireless device 1800 may be able to estimate (acquire) the timing advance value of candidate cell 1860 by performing measurements of downlink signals of candidate cell 1860. Based on the UE capability and/or the timing advance value, determined based on the UE capability, being available (valid), wireless device 1800 may determine not to perform random-access procedure 1830 and/or apply the timing advance measured by wireless device 1800.

Wireless device 1800 may complete the LTM procedure (e.g., determine that the LTM procedure is completed). This is illustrated in FIG. 18 as LTM completion 1832. During LTM completion 1832, wireless device 1800 transmits (e.g., to base station 1820 and/or on candidate cell 1860) a signal 1834 that indicates completion of the LTM cell switch. In an example, signal 1834 may indicate that an RRC reconfiguration (to candidate cell 1860) is complete. Additionally or alternatively, signal 1834 may be an RRC message, such as an RRC reconfiguration complete message.

Wireless device 1800 may determine (e.g., consider) that the LTM cell switch to candidate cell 1860 is successful (e.g., successfully completed) in different ways depending on, e.g., whether random-access procedure 1830 is performed or not performed (e.g., skipped). In other words, wireless device 1800 may determine that the LTM cell switch is successful (e.g., successfully completed) in different ways depending on, e.g., whether the LTM procedure is RACH-based LTM or RACH-less LTM.

For example, based on random-access procedure 1830 being performed (e.g., RACH-based LTM), wireless device 1800 may determine that LTM cell switch to candidate cell 1860 is successfully completed in response to random-access procedure 1830 to candidate cell 1860 being (successfully) completed.

As another example, based on not performing random-access procedure 1830 (e.g., RACH-less LTM) to candidate cell 1860, wireless device 1800 may determine that LTM cell switch to candidate cell 1860 is successfully completed in response to (successfully) transmitting uplink data (e.g., the RRC message indicating that the RRC reconfiguration is complete) on candidate cell 1860.

Wireless device 1800 may determine that the LTM cell switch to candidate cell 1860 is successfully completed in response to determining that the uplink data is successfully received by base station 1820 and/or on candidate cell 1860.

After LTM completion 1832, wireless device 1800 may communicate on candidate cell 1860 (as the serving cell, such as the primary cell, of wireless device 1800 and/or in RRC-Connected mode). For example, wireless device 1800 may receive one or more downlink signals 1836 on candidate cell 1860 (e.g., from base station 1820). The one or more downlink signals 1836 may comprise one or more RRC messages, one or more MAC CEs, and/or one or more DCIs. Wireless device 1800 may transmit one or more uplink signals 1838 on candidate cell 1860 (e.g., to base station 1820). The one or more uplink signals 1838 may comprise one or more RRC messages, one or more MAC CEs, and/or one or more UCIs.

In existing technologies, during an LTM procedure, a wireless device may transmit layer-1 RSRP reports of a candidate cell and the network (e.g., represented as a base station) may determine, based on the layer-1 RSRP reports, to switch a cell of the wireless device using LTM (e.g., to switch a serving cell or a primary cell). Based on the determination, the base station indicates to the wireless device to perform an LTM cell switch to the candidate cell by transmitting, to the wireless device, a command indicating to perform the LTM cell switch to the candidate cell. The command comprises information that the wireless device uses for the LTM cell switch to the candidate cell. An example of the command is illustrated in, e.g., FIG. 18 as command 1828.

A modification of the existing LTM procedure allows the wireless device to (autonomously) determine to perform an LTM cell switch to a candidate cell based on a condition (e.g., such as a condition based on the radio link quality of the candidate cell and/or the current serving cell of the wireless device). This modification allows the wireless device to perform the LTM cell switch to the candidate cell, without receiving the command (e.g., command 1828), in response to the condition being fulfilled. LTM cell switching based on a condition may be referred to as conditional LTM, conditional LTM cell switching, or LTM cell switching without a cell switch command (e.g., command 1828).

However, the wireless device may be unable to (successfully) complete the LTM cell switch based on the modification of the existing LTM procedure since, e.g., the command indicates information that the wireless device uses for performing a RACH-less LTM cell switch to the candidate cell (as discussed above in connection with FIG. 18 and command 1828). For example, the wireless device may perform a RACH-less LTM cell switch to the candidate cell using a timing advance value indicated by the command. Additionally or alternatively, the wireless device may perform a RACH-less LTM cell switch to the candidate case based on the command indicating that a timing advance acquired by the wireless device is valid.

Without the reception of the command, the wireless device may be unable to (successfully) perform a conditional LTM cell switch without a random-access procedure (and/or complete the LTM cell switch to) the candidate cell. This may further cause increased signaling overhead (e.g., due to retransmissions, repeated LTM procedures, and/or random access procedure being performed for a RACH-less LTM cell switch), decreased reliability (e.g., due to the LTM cell switch not being successfully completed), and latency (e.g., due to performing a RACH-based LTM instead of a RACH-less LTM).

According to embodiments of the present disclosure, the wireless device receives one or more capability inquiry messages requesting one or more capabilities of the wireless device. The wireless device transmits one or more capability information messages indicating one or more capabilities of the wireless device for RACH-less conditional LTM.

By indicating the one or more capabilities of the wireless device for RACH-less conditional LTM cell switching (e.g., in which the command, such as command 1828, does not indicate one or more fields for performing a RACH-less LTM cell switch), this may enhance reliability of performing conditional LTM cell switch without a random access procedure and/or increase reliability of conditional LTM cell switching. In addition, this may enable the network to determine (e.g., identify) which wireless devices may perform the conditional LTM cell switch without a random access procedure for conditional LTM cell switching when there is no command.

These and other additional effects may be provided by aspects of embodiments of the present disclosure.

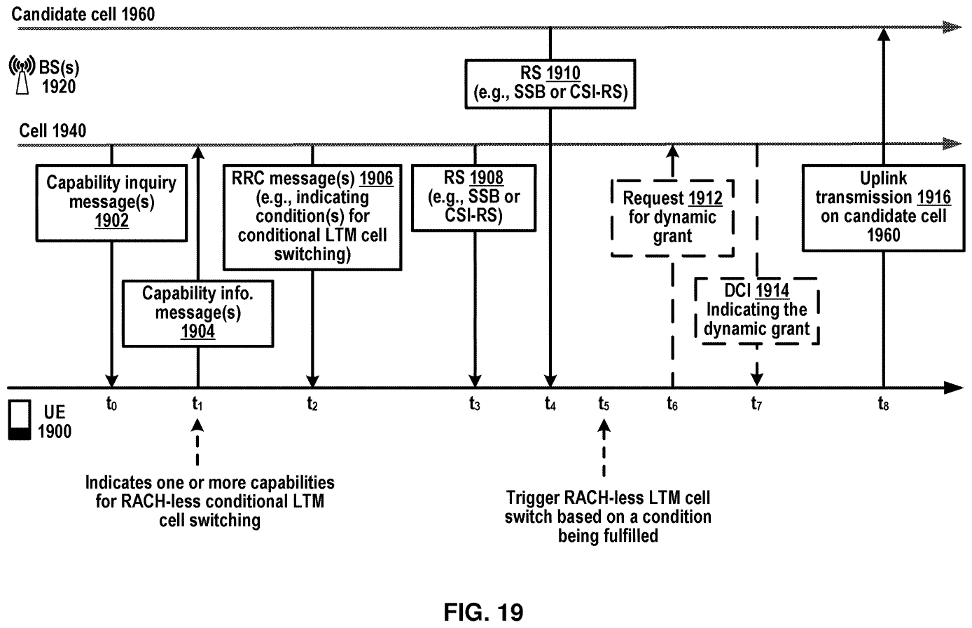

FIG. 19 illustrates an example of a wireless device 1900 performing a conditional LTM procedure with the cells of one or more base stations 1920. The conditional LTM procedure may be performed based on the LTM procedure illustrated in FIG. 18.

Wireless device 1900 performs an LTM cell switch between a cell 1940 and a candidate cell 1960 for LTM. Cell 1940 is, for example, a serving cell of wireless device 1900 (similar to cell 1840 of FIG. 18). Cell 1940 may be a primary cell of a cell group, such as a PCell of a Master Cell Group (MCG) or a PSCell of a Secondary Cell Group (SCG). Candidate cell 1960 is a candidate cell for LTM, such as a candidate for performing an LTM cell switch to (similar to candidate cell 1860 of FIG. 18). Cell 1940 may be a non-serving cell (e.g., a neighbor cell that is not a serving cell) or an SCell (e.g., an SCell of the MCG or an SCell of the SCG). Cell 1940 and candidate cell 1960 are both cells of one or more base stations 1920.

Cell 1940 may be referred to as a source cell (e.g., a cell as the source cell, a cell serving as a source cell, a cell as the source cell for LTM). Candidate cell 1960 may be referred to as an LTM candidate cell, a cell as a candidate cell, a cell as an LTM candidate cell, or a cell as an LTM candidate. For example, candidate cell 1960 may be referred to as a cell as an LTM candidate before LTM cell switching, and/or candidate cell 1960 may be referred to a cell as a serving cell after LTM cell switching.

As illustrated at t0 in FIG. 19, wireless device 1900 receives one or more capability inquiry messages 1902. Wireless device 1900 may receive one or more capability inquiry messages 1902 from one or more base stations 1920. For example, wireless device 1900 may receive one or more capability inquiry messages 1902 on cell 1940 (or another serving cell of wireless device 1900). Wireless device 1900 may receive one or more capability inquiry messages 1902 while in an RRC connected state. Additionally or alternatively, wireless device 1900 may receive one or more capability inquiry messages 1902 after access stratum (AS) security activation. One or more capability inquiry messages 1902 may be referred to as one or more UE capability inquiry (or enquiry) messages (e.g., UECapabilityEnquiry) or one or more messages requesting one or more capabilities of wireless device 1900.

At t1 in FIG. 19, wireless device 1900 transmits one or more capability information messages 1904. Wireless device 1900 may transmit one or more capability information messages 1904 to one or more base stations 1920. For example, wireless device 1900 may transmit one or more capability information messages 1904 on cell 1940 (or another serving cell of wireless device 1900). Wireless device 1900 may transmit one or more capability information messages 1904 based on (e.g., in response to, after, or when) receiving one or more capability inquiry messages 1902. One or more capability information messages 1904 may be referred to as one or more UE capability information messages (e.g., UECapabilityInformation) and/or one or more messages indicating one or more capabilities of wireless device 1900.

One or more capability information messages 1904 may indicate one or more capabilities of wireless device 1900. The one or more capabilities of wireless device 1900 may indicate (or comprise) one or more capabilities of wireless device 1900 for conditional LTM cell switching.

The one or more capabilities in one or more capability information messages 1904 may be indicated by one or more parameters (which may be referred to as one or more capability bits). The one or more parameters may indicate a value. The value may be an integer value (e.g., 0, 1, 2, 3, . . . 8), a Boolean value (e.g., true, false, 0, or 1), or an alphanumeric value (e.g., supported). The absence of one or more parameters (e.g., a value of the parameter) in one or more capability information messages 1904 may indicate that wireless device 1900 does not support the respective capability. As another example, the one or more parameters may (explicitly) indicate that the respective capability is not supported.

The one or more capabilities may be indicated for a given association level. In the present disclosure, a capability that is reported per a level indicates that the capability is associated with that level (e.g., per UE, per band, per band combination, per carrier, per feature set). For example, a capability reported per UE (or per wireless device) may indicate that the capability is signaled (e.g., using one parameter) for wireless device 1900. As another example, a capability reported per band may indicate that the capability is signaled for each (frequency) band that wireless device 1900 is configured with and/or supports (e.g., a one-to-one mapping between parameters and bands). As another example, a capability reported per band combination may indicate that the capability is signaled for each (frequency) band combination that wireless device 1900 is configured with and/or supports (e.g., a one-to-one mapping between parameters and band combination). As another example, a capability reported per carrier (or per cell) may indicate that the capability is signaled for each (e.g., component) carrier (or cell) that wireless device 1900 is configured with and/or supports (e.g., a one-to-one mapping between capability parameters and carriers (or cells)).

In reporting the capability per band, wireless device 1900 may report the capability for each band in each band combination. In reporting the capability per carrier (or per cell), wireless device 1900 may report the capability for each carrier in each band combination (e.g., for each carrier in each band of each band combination). As another example, a capability reported per feature set may indicate that the capability is signaled for a set of features. The set of features may be reported per band, per band combination, and/or per carrier.

Additionally or alternatively, wireless device 1900 may support one or more capabilities differently for FDD than TDD and/or between two or more frequency ranges (e.g., FR1 and FR2). Based on the one or more capabilities being supported differently for FDD and TDD, one or more capability information messages 1904 may indicate (or comprise) a value for FDD and a value for TDD. Based on the one or more capabilities being supported differently for the two or more frequency ranges (e.g., FR1 and FR2), one or more capability information messages 1904 may indicate a value for a first frequency range (e.g., FR1) and a value for a second frequency range (FR2). Based on wireless device 1900 supporting the one or more capabilities the same for FDD and TDD (and/or for the two or more frequency ranges) (e.g., regardless of whether the carrier is an FDD carrier or a TDD carrier, and/or regardless of the frequency range of the carrier), one or more capability information messages 1904 may indicate (or comprise) one value for FDD and TDD (and/or one value for the two or more frequency ranges, such as FR1 and FR2).

As an example of the one or more capabilities of the wireless device 1900 in one or more capability information messages 1904, the one or more capabilities may indicate whether wireless device 1900 supports conditional LTM cell switching. The support for the conditional LTM cell switching may be referred to as support for the conditional LTM cell switching with execution condition and candidate cell configuration.

By indicating whether wireless device 1900 supports conditional LTM cell switching, wireless device 1900 may indicate whether the wireless device supports conditional LTM cell switching for a maximum number of candidate cells. For example, by indicating that wireless device 1900 supports conditional LTM in one or more capability information messages 1904, the wireless device 1900 may (implicitly) indicate that wireless device 1900 supports conditional LTM cell switching for the maximum number of cells (e.g., up to n cells, such as up to a maximum of eight cells).

One or more capability information messages 1904 may indicate the one or more capabilities that wireless device 1900 supports for conditional LTM per band (e.g., on a per band basis). For example, one or more capability information messages 1904 may indicate whether wireless device 1900 supports conditional LTM for a first band (e.g., first frequency band) and whether wireless device 1900 supports conditional LTM for a second band (e.g., second frequency band). One or more capability information messages 1904 may indicate that conditional LTM is not supported differently for FDD and TDD. One or more capability information messages 1904 may indicate that conditional LTM is not supported differently for two or more frequency ranges (e.g., FR1 and FR2). For example, by indicating that wireless device 1900 supports conditional LTM, the support is indicated (to be the same) for FDD and TDD (and/or the two or more frequency ranges).

One or more capability information messages 1904 may indicate one or more capabilities for LTM cell switching based on a command. The command in the LTM cell switching may be a MAC CE and/or implemented based on command 1828.

Additionally or alternatively, the one or more capabilities of wireless device 1900 for conditional LTM cell switching, in one or more capability information messages 1904, may indicate (or comprise) one or more capabilities of wireless device 1900 for RACH-less conditional LTM cell switching. The one or more capabilities may be for performing (RACH-less) LTM cell switching without a random-access procedure (e.g., without random-access procedure 1830) during a conditional LTM cell switch as discussed above in FIG. 18.

As an example, the one or more capabilities of wireless device 1900 for RACH-less conditional LTM cell switching may indicate whether wireless device 1900 supports RACH-less conditional LTM.

The one or more capabilities of wireless device 1900 in one or more capability information messages 1904 may indicate whether the wireless device supports RACH-less conditional LTM with an uplink configured grant. The one or more capabilities of wireless device 1900 in one or more capability information messages 1904 may indicate whether the wireless device supports RACH-less conditional LTM with an uplink configured grant for a cell group. The cell group may be an MCG and/or an SCG. The one or more capabilities may indicate, per UE, whether the wireless device supports RACH-less conditional LTM with the uplink configured grant.

Additionally or alternatively, the one or more capabilities of wireless device 1900 in one or more capability information messages 1904 may indicate whether the wireless device supports RACH-less conditional LTM with a dynamic grant. The one or more capabilities of wireless device 1900 in one or more capability information messages 1904 may indicate whether the wireless device supports RACH-less conditional LTM with a dynamic grant for a cell group. The cell group may be an MCG and/or an SCG. The one or more capabilities may indicate, per UE, whether the wireless device supports RACH-less conditional LTM with the dynamic grant.

As explained above, one or more capability information messages 1904 may indicate whether wireless device 1900 supports conditional LTM. Wireless device 1900 may be configured to indicate support of the conditional LTM cell switching based on wireless device 1900 indicating support of the one or more capabilities for RACH-less conditional LTM cell switching in one or more capability information messages 1904.

As also explained above, one or more capability information messages 1904 may indicate one or more capabilities of wireless device 1900 for LTM cell switching based on a command (e.g., command 1828).

The one or more capabilities for RACH-less conditional LTM cell switching in one or more capability information messages 1904 may (also) indicate the one or more capabilities of wireless device 1900 for RACH-less LTM cell switching based on the command. For example, by indicating that wireless device 1900 supports RACH-less conditional LTM with an uplink configured grant and/or RACH-less conditional LTM with a dynamic grant, one or more capability information messages 1904 may also indicate, respectively, that wireless device 1900 supports RACH-based LTM based on the command with an uplink configured grant and/or RACH-based LTM based on the command with a dynamic grant.

Alternatively, separate indications may be included in one or more capability information messages 1904 to indicate whether wireless device 1900 supports the one or more capabilities for RACH-less LTM cell switching based on the command. Examples of separate indications are provided below that may be included in one or more capability information messages 1904 in addition to the one or more capabilities discussed above for conditional LTM.

The one or more capabilities of wireless device 1900 in one or more capability information messages 1904 may indicate whether the wireless device supports RACH-less LTM with an uplink configured grant (e.g., where the RACH-less LTM is based on the command). The one or more capabilities of wireless device 1900 in one or more capability information messages 1904 may indicate whether the wireless device supports RACH-less LTM with an uplink configured grant for a cell group. The cell group may be an MCG and/or an SCG. The one or more capabilities may indicate, per UE, whether the wireless device supports RACH-less LTM with the uplink configured grant.

Additionally or alternatively, the one or more capabilities of wireless device 1900 in one or more capability information messages 1904 may indicate whether the wireless device supports RACH-less conditional LTM with a dynamic grant (e.g., where the RACH-less LTM is based on the command). The one or more capabilities of wireless device 1900 in one or more capability information messages 1904 may indicate whether the wireless device supports RACH-less LTM with a dynamic grant for a cell group. The cell group may be an MCG and/or an SCG. The one or more capabilities may indicate, per UE, whether the wireless device supports RACH-less LTM with the dynamic grant.

As illustrated at t2 in FIG. 19, wireless device 1900 receives, on cell 1940, one or more RRC messages 1906. One or more RRC messages 1906 may be implemented based on, e.g., one or more RRC messages 1802 in FIG. 18. One or more RRC messages 1906 may comprise configuration parameters of one or more candidate cells for conditional LTM cell switching.

One or more base stations 1920 may set (e.g., change, alter, or adjust) any of the configuration parameters based on the one or more capabilities indicated by one or more capability information messages 1904. Additionally or alternatively, one or more base stations 1920 may determine not to set (e.g., change, alter, or adjust) one or more (or any) of the configuration parameters based on the one or more capabilities indicated by one or more capability information messages 1904. The one or more capability information messages 1904 may provide greater flexibility to the network in setting the configuration parameters in one or more RRC messages 1906 for LTM.

As an example, one or more RRC messages 1906 may indicate one or more candidate cells for LTM. The one or more candidate cells for LTM comprise candidate cell 1960. Additionally or alternatively, one or more RRC messages 1906 may indicate an LTM candidate configuration of candidate cell 1960. The configuration parameters may indicate one or more conditions for performing the conditional LTM cell switching to the one or more candidate cells. The one or more conditions may be referred to as one or more execution conditions.

A number of the one or more candidate cells indicated by one or more RRC messages 1906 may be equal to, or less than, the one or more maximum numbers indicated by wireless device 1900 in one or more capability information messages 1904.

The configuration parameters of candidate cell 1960 for LTM may be associated with a cell group, such as an MCG or a SCG. In an example, the configuration parameters of candidate cell 1960 may be for the MCG or the SCG based on the signaling radio bearer (SRB) via which the configuration parameters are received. For example, based on receiving the configuration parameters on a first SRB (e.g., SRB1), the configuration parameters of candidate cell 1960 for LTM may be associated with the MCG. On the other hand, based on receiving the configuration parameters on a second SRB (e.g., an SRB other than SRB1, such as SRB3), the configuration parameters of candidate cell 1960 for LTM may be associated with the SCG. As another example, the configuration parameters of candidate cell 1960 may comprise a (separate) configuration for the SCG (e.g., embedded in the RRC signaling received via SRB1). As yet another example, a parameter may be included to (explicitly) indicate whether the configuration parameters of candidate cell 1960 are for the MCG and/or the SCG.

The configuration parameters of candidate cell 1960 may be associated with the MCG and/or the SCG based on wireless device 1900 indicating support for RACH-less LTM with a dynamic grant (and/or support for conditional LTM) in one or more capability information messages 1904 for the MCG and/or SCG.

The configuration parameters may indicate an uplink configured grant LTM configuration for performing a RACH-less LTM cell switch to candidate cell 1960. The uplink configured grant LTM configuration may be a type 1 uplink configured grant configuration. An uplink grant of the type 1 uplink configured grant configuration is configured by RRC. Additionally or alternatively, the uplink grant of the type 1 uplink configured grant configuration is not configured by a downlink control information (DCI). The uplink configured grant configuration is associated with a synchronization signal (SS) block (SSB) of candidate cell 1960.

The configuration parameters may the uplink configured grant LTM configuration for performing a RACH-less LTM cell switch based on wireless device 1900 indicating support for RACH-less LTM in one or more capability information messages 1904.

One or more RRC messages 1906 may indicate an uplink resource configuration for requesting a dynamic grant. The dynamic grant may be for the RACH-less LTM cell switch. The uplink resource configuration may be a scheduling request (SR) configuration. The uplink resource configuration may indicates at least one of: a physical uplink control channel (PUCCH) resource identifier (ID); a periodicity of an uplink resource (e.g., PUCCH); and/or a value of a timer. The timer may be an SR prohibit timer (e.g., where wireless device 1900 does not retransmit the SR while the SR prohibit timer is running and/or retransmits at the expiration of the SR prohibit timer).

The configuration parameters may the uplink resource configuration for performing a RACH-less LTM cell switch based on wireless device 1900 indicating support for RACH-less LTM with a dynamic grant (and/or support for conditional LTM) in one or more capability information messages 1904.

One or more RRC messages 1906 may indicate one or more reference signals (e.g., SSBs and/or CSI-RSs), of candidate cell 1960, for performing measurements of candidate cell 1960. One or more RRC messages 1906 may indicate one or more candidate TCI states, of candidate cell 1960, for LTM.

For example, one or more RRC messages 1906 may indicate one or more resources of the one or more reference signals for the measurement reports of the candidate cell 1960. One or more RRC messages 1906 may indicate a report configuration for the measurement reports of the one or more reference signals of candidate cell 1960.

In an example, the LTM candidate configuration, of candidate cell 1960, may indicate the one or more resources of the one or more reference signals of candidate cell 1960. Additionally or alternatively, the LTM candidate configuration, of candidate cell 1960, may indicate the report configuration for the measurement reports of the one or more reference signals.

One or more RRC messages 1906 may indicate candidate TCI states, of candidate cell 1960, for LTM. For example, one or more RRC messages 1906 may indicate a list of candidate TCI states, of the candidate cell 1960, for LTM. The candidate TCI states may be implemented based on the candidate TCI states (and/or the list of candidate TCI states) indicated by one or more RRC messages 1802. One or more RRC messages 1906 may indicate (both) the candidate TCI states of candidate cell 1960 and TCI states of cell 1940 (e.g., implemented based on the one or more TCI states configured by one or more RRC messages 1702 and/or one or more RRC messages 1714).

The list of candidate TCI states, of candidate cell 1960, may indicate one or more reference signals of candidate cell 1960 (e.g., one or more resources of the one or more reference signals and/or one or more (reference signal) resource configurations of the one or more reference signals). A subset of the one or more reference signals indicated by the list of candidate TCI states may be activated by a MAC CE (e.g., implemented based on MAC CE 1808).

For example, wireless device 1900 may receive (e.g., after t2) a MAC CE (e.g., MAC CE 1808) indicating activation of (e.g., a subset of) candidate TCI states from among the list of candidate TCI states of candidate cell 1960. The MAC CE (e.g., MAC CE 1808) may be received from one or more base stations 1920, on cell 1940, and/or on another cell of one or more base stations 1920 (e.g., a cell that is not cell 1940 similar to one or more RRC messages 1906 as discussed above). By indicating activation of the candidate TCI state, the MAC CE indicates the one or more reference signals of candidate cell 1960.

One or more RRC messages 1906 may indicate a quasi co-location (QCL) relationship of a reference signal for measurement and another reference signal. For example, a (reference signal) resource configuration of a reference signal may indicate a candidate TCI state. The candidate TCI state may indicate a QCL source of the reference signal. For example, the reference signal may be an CSI-RS, and the candidate TCI state may indicate that the QCL source of the CSI-RS is an SSB. As an example, the candidate TCI state may indicate the SSB index of the SSB, and the (reference signal) resource configuration of the reference signal may indicate the TCI state ID of the candidate TCI state.

As illustrated at t3 in FIG. 19, wireless device 1900 receives a reference signal 1908 of cell 1940. Reference signal 1908 may be an SSB and/or a CSI-RS of cell 1940. Reference signal 1908 may be indicated by one or more RRC messages 1906. Reference signal 1908 may be indicated by a TCI state (e.g., an activated TCI state) of cell 1940. For example, reference signal 1908 may be implemented based on a reference signal indicated by a TCI state configured by one or more RRC messages 1702 and/or one or more RRC messages 1714 as discussed above in connection with FIGS. 17A and 17B.

As illustrated at t4 in FIG. 19, wireless device 1900 receives a reference signal 1910 of candidate cell 1960. Reference signal 1910 may be an SSB and/or a CSI-RS of candidate cell 1960. Reference signal 1910 may be implemented based on, e.g., reference signal 1810 and/or reference signal 1822. Reference signal 1910 may be from among (e.g., a reference signal of) the one or more reference signals for performing measurements of candidate cell 1960 (indicated by one or more RRC messages 1906 and/or by one or more candidate TCI states activated by a MAC CE, such as MAC CE 1808 that indicates activation of reference signal 1810).

As illustrated at t5 in FIG. 19, wireless device 1900 triggers a conditional LTM cell switch to candidate cell 1960 based on a condition being fulfilled. The condition may be a condition among the one or more conditions indicated by one or more RRC messages 1906.

As an example, wireless device 1900 triggers the conditional LTM cell switch based on (e.g., in response to, when, and/or if) reference signal 1908 of cell 1940, and/or reference signal 1910 of candidate cell 1960, fulfilling a condition for LTM cell switching. Reference signal 1908 and reference signal 1910 may be referred to as triggering reference signals (e.g., triggering reference signals for the conditional LTM cell switch). The conditional LTM cell switch may be a RACH-less LTM cell switch implemented based on the LTM procedure illustrated in FIG. 18 (e.g., implemented without command 1828).

The condition may be fulfilled based on a comparison of a radio link quality of reference signal 1908 of cell 1940 and a radio link quality of reference signal 1910 of candidate cell 1960. The comparison of the radio link quality of reference signal 1908 and the radio link quality of reference signal 1910 may be to one or more threshold values. The one or more threshold values may be (or comprise) one or more absolute threshold values and/or one or more relative threshold values. As an example, an absolute threshold value may indicate a threshold value (e.g., received signal power, such as layer-1 RSRP) in dBm (decibel-milliwatts) and/or an index to a threshold value in a list or a table. As another example, a relative threshold value may indicate an offset value (e.g., a difference in value, a differential value, or an absolute value of the differential value) of the radio link qualities of two reference signals (e.g., in dBm).

The one or more threshold values may comprise a threshold value (e.g., a first threshold value) for the radio link quality of reference signal 1908 of cell 1940 and a threshold value (e.g., a second threshold value) for the radio link quality of reference signal 1910 of candidate cell 1960. The condition may be fulfilled based on the radio link quality of reference signal 1908 of cell 1940 fulfilling the first threshold value and the radio link quality of reference signal 1910 of candidate cell 1960 fulfilling the second threshold value.

Additionally or alternatively, the one or more threshold values may be an offset value. The condition may be fulfilled based on the radio link quality of reference signal 1908 of cell 1940 being worse than the radio link quality of reference signal 1910 of candidate cell 1960 by the offset value. As another example, the condition may be fulfilled based on the radio link quality of reference signal 1908 of cell 1940 being better than the radio link quality of reference signal 1910 of candidate cell 1960 by the offset value.

For the comparison, the reference signal type of reference signal 1908 and reference signal 1910 may be the same. For example, reference signal 1908 and reference signal 1910 may both be an SSB. As another example, reference signal 1908 and reference signal 1910 may both be a CSI-RS.

To perform the conditional LTM cell switch, wireless device 1900 may perform an LTM procedure implemented based on FIG. 18 to switch (e.g., the serving cell of wireless device 1900, such as a primary cell) from cell 1940 to candidate cell 1960. Additionally or alternatively, wireless device 1900 may detach from cell 1940 (e.g., as the primary cell) and/or apply one or parameters, of candidate cell 1960, indicated by one or more RRC messages 1906 (e.g., an LTM candidate configuration of candidate cell 1960). By applying the one or more parameters of candidate cell 1960, candidate cell 1960 may become the primary cell (e.g., the PCell or PSCell) of wireless device 1900. The LTM candidate configuration, of candidate cell 1960, may be implemented based on the LTM candidate configuration, of candidate cell 1860, indicated by one or more RRC messages 1802 in FIG. 18.

Based on one or more capability information messages 1904 indicating that wireless device 1900 supports the one or more capabilities for RACH-less conditional LTM cell switching, wireless device 1900 may perform the LTM cell switch without a random-access procedure.

As an example, the conditional LTM cell switch triggered at t5 in FIG. 19 is a conditional LTM cell switch without a random-access procedure (e.g., without RACH or without a RACH procedure). The conditional LTM cell switch without RACH may be referred to as a RACH-less conditional LTM cell switch. The RACH-less conditional LTM cell switch may be implemented based on the RACH-less LTM cell switch (performed without random-access procedure 1830 and/or FIGS. 13A-13C) as discussed above in connection with FIG. 18.

The RACH-less conditional LTM cell switch may be based on the uplink configured grant and/or the dynamic grant. For RACH-less conditional LTM cell switching with the dynamic grant, the dynamic grant may be used based on, e.g., the uplink configured grant no longer being valid. For example, wireless device 1900 may determine that the uplink configurated grant is no longer valid (e.g., a PUSCH occasion associated with the SSB of the uplink configured grant is not valid).

In LTM cell switching based on the command, the command may comprise a dynamic grant for performing the LTM cell switch. However, without the command, wireless device 1900 may not have a dynamic grant for the RACH-less cell switch for conditional LTM. Additionally or alternatively, one or more base stations 1920 may not (e.g., be able to) determine that the uplink configured grant is not valid and/or that a dynamic grant should be sent.

As illustrated at t6 in FIG. 19, wireless device 1900 may transmit a request 1912 for the dynamic grant to one or more base stations 1920. Request 1912 may be transmitted on cell 1940 (or another serving cell). Additionally or alternatively, request 1912 may be transmitted to candidate cell 1960. Request 1912 may be transmitted based on the uplink resource configuration (indicated by one or more RRC messages 1906). Request 1912 may be transmitted in response to the configured grant not being valid.

As illustrated at t7 in FIG. 19, wireless device 1900 may receive a DCI 1914 indicating the dynamic grant. The dynamic grant may be received after (e.g., based on or in response to) transmitting request 1912. Additionally or alternatively, the dynamic may be received without wireless device 1900 transmitting request 1912.

It should be noted that the features of transmitting request 1912 and/or receiving DCI 1914 are optional and may be omitted in an example. Similarly, one or more RRC messages 1906 may not indicate the uplink resource configuration for request 1912. For example, request 1912 be omitted and DCI 1914 may still be received in an example. In another example, both request 1912 and DCI 1914 may be omitted. To illustrate these aspects, request 1912 and DCI 1914 are illustrated with dotted lines in FIG. 19.

As illustrated at t8 in FIG. 19, wireless device 1900 transmits an uplink transmission 1916 on candidate cell 1960. Uplink transmission 1916 may be transmitted for the conditional LTM cell switching. For example, uplink transmission 1916 may be a PUSCH transmission. Additionally or alternatively, uplink transmission 1916 may indicate that RRC reconfiguration to candidate cell 1960 is complete. Uplink transmission 1916 may be based implemented based on signal 1834.

Uplink transmission 1916 may be transmitted based on the uplink configured grant configuration. For example, the uplink transmission may be based on a PUSCH occasion determined based on the SSB indicated by the uplink configured grant configuration. Additionally or alternatively, uplink transmission 1916 may be transmitted based on a dynamic grant. The dynamic grant may be indicated by DCI 1914 (e.g., after transmitting request 1912 and/or without request 1912).

In FIG. 19, LTM cell switching is triggered based on a reference signal, of a candidate cell, and a reference signal, of the serving cell, fulfilling a condition. Examples of the condition for LTM cell switching are provided below. However, it should be understood that the present disclosure is not particularly limited to these examples and other examples (e.g., conditions for LTM cell switching) are within the scope of the present disclosure.

The radio link quality may be an RSRP, a layer-1 RSRP, an SINR, a layer-1 SINR, or any other quantity indicative of signal strength. The threshold value and/or the offset value may also be an RSRP value, a layer-1 RSRP value, an SINR value, a layer-1 SINR value, or any other quantity value indicative of signal strength.

In the present disclosure, a threshold value may be referred to as an absolute threshold value (e.g., a total signal strength) of a radio link quantity (e.g., RSRP, a layer-1 RSRP, a SINR, a layer-1 SINR). The threshold value may be referred to as a threshold or an absolute threshold value. Additionally or alternatively, the threshold value may refer to a relative threshold value. The relative threshold value may be referred to as a differential threshold value. The differential threshold value may be an absolute value of the differential threshold value.

In addition, the threshold value may be specific to the LTM procedure. For example, the threshold value may be referred to as a threshold value for performing LTM cell switching, a threshold value for LTM, or a threshold value for LTM cell switching. The threshold value may be cell specific or common to multiple cells (e.g., common to all candidate cells or one for each candidate cell among candidate cells).

In the present disclosure, an offset value may be referred to a differential offset value (e.g., a difference in signal strength) of a radio link quantity (e.g., RSRP, a layer-1 RSRP, a SINR, a layer-1 SINR). The offset value may be referred to as an offset, a relative offset value, or a differential offset value. Additionally or alternatively, the offset value may be referred to as a threshold value, such as a threshold, a relative threshold value, or a differential threshold value. The offset value may be an absolute value of the offset value (e.g., an absolute value of the difference in signal strength).

In addition, the offset value may be specific to the LTM procedure. For example, the offset value may be referred to as an offset value for performing LTM cell switching, an offset value for LTM, or an offset value for LTM cell switching. The offset value may be cell specific or common to multiple cells (e.g., common to all candidate cells or one for each candidate cell among candidate cells).

The threshold value and/or offset value may be configured by one or more messages. For example, as illustrated at t2 in FIG. 19, wireless device 1900 receives one or more RRC messages 1906. One or more RRC messages 1906 may indicate the threshold value and/or the offset value of the condition for LTM cell switching. For example, one or more RRC messages 1906 may comprise a value of (or for) the threshold value and/or the offset value. The value may be used as the threshold value and/or the offset value (e.g., the threshold value and/or the offset may be set to the value), or the value may be used to determine the threshold value and/or the offset value. Additionally or alternatively, the threshold value and/or the offset value may be preconfigured in wireless device 1900 (e.g., without being indicated to wireless device 1900 via any messages, such as any RRC messages).

In the present disclosure, the terms lowest and highest may be used in connection with a value of an identifier, such as a lowest ID, a lowest codepoint value, a highest ID, and/or a highest codepoint value. The term lowest may be referred to as smallest (e.g., a smallest ID). The term highest may be referred to as largest (e.g., a largest ID).

As explained above an example of the condition for LTM cell switching, the condition that reference signal 1910 fulfils may be, or comprise, a comparison of a radio link quality of reference signal 1910, of candidate cell 1960, to a threshold value or an offset value. Additionally or alternatively, the condition that reference signal 1910 fulfils may be, or comprise, a comparison of a radio link quality of reference signal 1908 (e.g., an SSB or a CSI-RS), of cell 1940 (e.g., a serving cell, a source cell, and/or a primary cell of wireless device 1900 before the conditional LTM cell switch), to a threshold value or an offset value. Additional examples of the condition, which may be substituted for and/or combined with these examples, for LTM cell switching are provided below.

As an example, a condition (e.g., a first condition) may be that a radio link quality of a reference signal 1908 (e.g., SSB or CSI-RS) of cell 1940 is better than (e.g., greater than, higher than) a threshold value for performing LTM cell switching. As another example, the condition (e.g., a second condition) may be that a radio link quality of reference signal 1908 of cell 1940 is worse than (e.g., less than, lower than) a threshold value for performing LTM cell switching. As another example, the condition (e.g., a third condition) may be that a radio link quality of reference signal 1910 of candidate cell 1960 is better than the radio link quality of (e.g., a reference signal of) the cell by an offset value for performing LTM cell switching. As yet another example, the condition (e.g., a fourth condition) may be that the radio link quality of reference signal 1910 of candidate cell 1960 is better than a threshold value for performing LTM cell switching.

The condition for LTM cell switching may be based on multiple threshold values and/or offset values. The condition may be based on a comparison of a radio link quality to a threshold value for cell 1940 and another comparison of a radio link quality to another threshold value for candidate cell 1960. As an example, the condition (e.g., a fifth condition) may be the following: the radio link quality, of reference signal 1908 of cell 1940, is worse than a first threshold for performing LTM cell switching; and a radio link quality of reference signal 1910 of candidate cell 1960 is better than a second threshold for performing LTM cell switching.

In the present disclosure, the condition may be referred to as a trigger, a trigger condition, an execution condition, an event, a triggering event, or a conditional event. Fulfilling the condition may be referred to as satisfying the condition, meeting the condition, or detecting the condition.

In the present disclosure, a (current) serving cell (e.g., a source cell, such as cell 1940) and a candidate cell (e.g., candidate cell 1960) may each be indicated with (e.g., separate) one or more conditions for conditional LTM cell switching.

Additionally or alternatively, the example conditions provided in the present disclosure may be used to trigger a measurement report (e.g., in addition to triggering LTM cell switching), such as a layer-1 measurement (e.g., layer-1 RSRP or layer-1 SINR) report, in addition to triggering the LTM cell switching.

Using FIG. 19 as an example, wireless device 1900 receives reference signal 1910 as illustrated at t4. After t4 (e.g., and before t5), wireless device 1900 may transmit one or more measurement reports, of reference signal 1910, in response to (e.g., if and/or when) reference signal 1910 fulfilling the condition. The one or more measurement reports, and the transmitting of the one or more measurement reports, may be implemented based on report 1824 and FIG. 18.

Wireless device 1900 may trigger the conditional LTM cell switch based on reference signal 1908 and/or reference signal 1910 fulfilling the condition one time or a number of times over a time period (where the number of times is greater than one). Additionally or alternatively, wireless device 1900 may trigger the conditional LTM cell switch based on reference signal 1908 and/or reference signal 1910 fulfilling at least two conditions (e.g., fulfilling at least two conditions one time or fulfilling at least two conditions a number of times over a time period).

By using the condition being fulfilled a number of times and/or at least two conditions being fulfilled, this may improve reliability in performing LTM cell switching (e.g., based on not performing the LTM cell switching too frequently or in response to transient instances of the condition being fulfilled).

As an example based on FIG. 19, wireless device 1900 may transmit, to cell 1940 and/or one or more base stations 1920, one or more measurement reports of reference signal 1910 of candidate cell 1960. Wireless device 1900 may transmit the one or more measurement reports based on reference signal 1910 fulfilling a condition. After (or before) transmitting the one or more measurement reports, wireless device 1900 may, as illustrated at t5 in FIG. 19, trigger the conditional LTM cell switch based on reference signal 1908 and/or reference signal 1910 fulfilling the condition. Wireless device 1900 may trigger the conditional LTM cell switch based on reference signal 1908 and/or reference signal 1910 fulfilling the condition one time or a number of times over a time period (where the number of times is greater than one). Additionally or alternatively, wireless device 1900 may trigger the conditional LTM cell switch based on reference signal 1908 and/or reference signal 1910 fulfilling at least two conditions (e.g., one time or a number of times over a time period).

By using the condition being fulfilled a number of times and/or at least two conditions being fulfilled when one or more measurement reports are also based on the condition, this may improve reliability in performing LTM cell switching (e.g., based on not performing the LTM cell switching too frequently or in response to transient instances of the condition being fulfilled) and provide greater flexibility to the network (e.g., may configure the same conditions for both and/or allow network to transmit a command, such as command 1828, before the wireless device autonomously triggers LTM cell switching).

In the present disclosure, the wireless device triggers the LTM cell switch based on a condition. Triggering the LTM cell switch may be referred to as starting the LTM cell switch, initiating the LTM cell switch, or determining to (e.g., start, perform, initiate) the LTM cell switch. The LTM cell switch to a candidate cell may be referred to as a cell switch to the candidate cell based on LTM, an LTM procedure for (or to) the candidate cell, a conditional LTM procedure for (or to) the candidate cell, and/or a conditional LTM cell switch to the candidate cell.

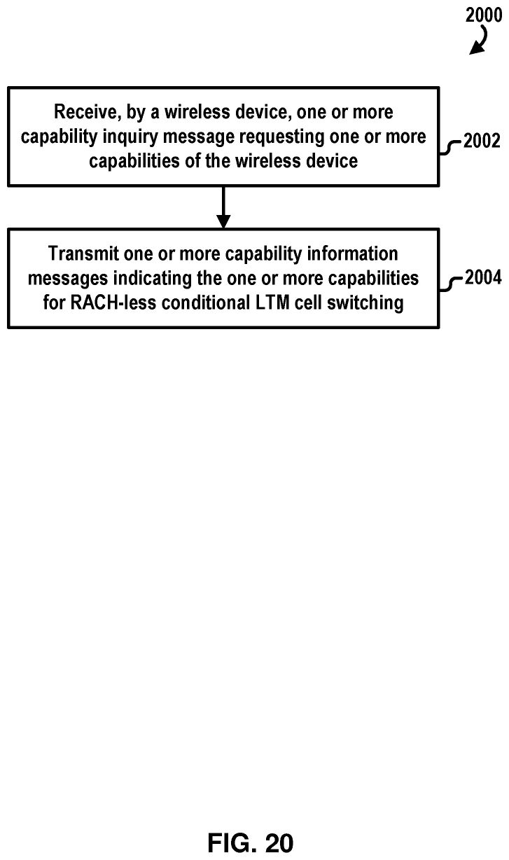

FIG. 20 illustrates a process 2000 according to an embodiment of the present disclosure. The aspects of the process 2000 in FIG. 20 may be implemented by the wireless device discussed above in connection with FIGS. 17A, 17B, 18, and/or 19.

As illustrated in FIG. 20, process 2000 comprises a step 2002 of receiving, by a wireless device, one or more capability inquiry messages requesting one or more capabilities of the wireless device.

Process 2000 may further comprise a step 2004 of transmitting one or more capability information messages indicating one or more capabilities of the wireless device for RACH-less conditional LTM cell switching.

Additional aspects, with examples, of step 2002, step 2004, and process 2000 are discussed below. Each of the additional aspects, and examples, below may be considered an embodiment. Each aspect of the embodiments may be combined with, or substituted for, the aspects of the embodiment of process 2000 illustrated in FIG. 20, such as step 2002 and/or step 2004. Furthermore, each of the additional aspects and examples below may be combined with each other.

In an example, the one or more capabilities further indicate whether the wireless device supports conditional LTM cell switching.

In an example, the support for the conditional LTM cell switching is support for the conditional LTM cell switching with execution condition and candidate cell configuration.

In an example, the one or more capabilities information messages indicate whether the wireless device supports conditional LTM cell switching for a maximum number of candidate cells.

In an example, the maximum number of candidate cells is up to eight candidate cells.

In an example, the one or more capability information messages indicate, per band, whether the wireless device supports conditional LTM cell switching.

In an example, the one or more capability information messages further indicate one or more capabilities for LTM cell switching based on a command.

In an example, the one or more capabilities for LTM cell switching based on the command comprise one or more capabilities of the wireless device for RACH-less LTM cell switching based on the command.

In an example, the command is a MAC CE or a cell switch command.

In an example, the one or more capabilities indicate whether the wireless device supports RACH-less conditional LTM with an uplink configured grant.

In an example, the RACH-less conditional LTM with the uplink configured grant is for a cell group.

In an example, the cell group is a master cell group (MCG) and/or a secondary cell group (SCG).

In an example, the one or more capabilities indicate, per UE, whether the wireless device supports RACH-less conditional LTM with the uplink configured grant.

In an example, the one or more capabilities indicate whether the wireless device supports RACH-less conditional LTM with a dynamic grant.

In an example, the RACH-less conditional LTM with the dynamic grant is for a cell group.

In an example, the cell group is an MCG and/or an SCG.

In an example, the one or more capabilities indicate, per UE, whether the wireless device supports RACH-less conditional LTM with a dynamic grant.

In an example, process 2000 further comprises a step of receiving one or more radio resource control (RRC) messages comprising configuration parameters of a candidate cell for LTM.

In an example, the configuration parameters indicate one or more conditions for performing the conditional LTM cell switching to the one or more candidate cells.

In an example, the one or more conditions are one or more execution conditions.

In an example, the configuration parameters of the candidate cell for LTM are associated with an MCG.

In an example, the configuration parameters of the candidate cell for LTM are associated with the MCG based on a signal radio bearer (SRB) that the one or more RRC messages are received on.

In an example, the configuration parameters of the candidate cell for LTM are associated with a SCG.

In an example, the configuration parameters of the candidate cell for LTM are associated with the SCG based on the SRB that the one or more RRC messages are received on.

In an example, the configuration parameters indicate an uplink configured grant LTM configuration for performing a RACH-less LTM cell switch to the candidate cell.

In an example, the uplink configured grant LTM configuration is a type 1 uplink configured grant configuration.

In an example, an uplink grant of the type 1 uplink configured grant configuration is configured by RRC.

In an example, the uplink grant of the type 1 uplink configured grant configuration is not configured by a downlink control information (DCI).

In an example, the uplink configured grant configuration is associated with a synchronization signal (SS) block (SSB) of the candidate cell.

In an example, the configuration parameters indicate an uplink resource configuration for requesting the dynamic grant.

In an example, the uplink resource configuration is a scheduling request (SR) configuration.

In an example, the uplink resource configuration indicates at least one of: a physical uplink control channel (PUCCH) resource identifier (ID); a periodicity of an uplink resource; and/or a value of a timer.

In an example, the timer is a SR prohibit timer.

In an example, process 2000 further comprises a step of triggering a conditional LTM cell switch of a serving cell to the candidate cell based on fulfilling a condition among the one or more conditions.

In an example, the condition is fulfilled based on a comparison of: a radio link quality of a reference signal of the candidate cell and a radio link quality of a reference signal of the serving cell.

In an example, the comparison is of the radio link quality of the reference signal of the candidate cell and the radio link quality of the reference signal of the serving cell to one or more threshold values.

In an example, the one or more threshold values comprise absolute threshold values.

In an example, the one or more threshold values comprise: a threshold value for the radio link quality of the reference signal of the candidate cell; and a threshold value for the radio link quality of the reference signal of the serving cell.

In an example, the one or more threshold values comprise a relative offset value.

In an example, the relative offset value is a differential value between the radio link quality of the reference signal of the candidate cell and the radio link quality of the reference signal of the serving cell.

In an example, the reference signal of the candidate cell is a channel state information reference signal (CSI-RS) of the candidate cell; and the reference signal of the serving cell is a CSI-RS of the serving cell.

In an example, the reference signal of the candidate cell is an SSB of the candidate cell; and the reference signal of the serving cell is an SSB of the serving cell.

In an example, process 2000 further comprises a step of transmitting a request for a dynamic grant.

In an example, the dynamic grant is transmitted based on the uplink resource configuration.

In an example, the request is transmitted in response to the uplink configured grant not being valid.

In an example, process 2000 further comprises a step of receiving a DCI indicating the dynamic grant.

In an example, the dynamic grant is received based on transmitting the request.

In an example, process 2000 further comprises a step of transmitting, on the candidate cell and for the conditional LTM cell switching, an uplink transmission.

In an example, the uplink transmission indicates that an RRC reconfiguration to the candidate cell is complete.

In an example, the uplink transmission a physical uplink shared channel (PUSCH) transmission.

In an example, the PUSCH transmission is based on the uplink configured grant configuration.

In an example, the PUSCH transmission is based on a PUSCH occasion determined based on the SSB indicated by the uplink configured grant configuration.

In an example, the PUSCH transmission is based on a dynamic grant.

In an example, the dynamic grant is indicated by the DCI received after transmitting the request for the dynamic grant.

An apparatus (e.g., a wireless device) comprising one or more processors and memory storing instructions that, when executed by the one or more processors, may cause the apparatus to perform process 2000 and/or any one or more of the above examples.

A (non-transitory) computer-readable medium may comprise instructions that, when executed by one or more processors of an apparatus (e.g., a wireless device), may cause the apparatus to perform process 2000 and/or any one or more of the above examples.

A system may comprise a base station and an apparatus (e.g., a wireless device) that may comprise one or more processors and memory storing instructions that, when executed by the one or more processors, may cause the apparatus to perform process 2000 and/or any one or more of the above examples.

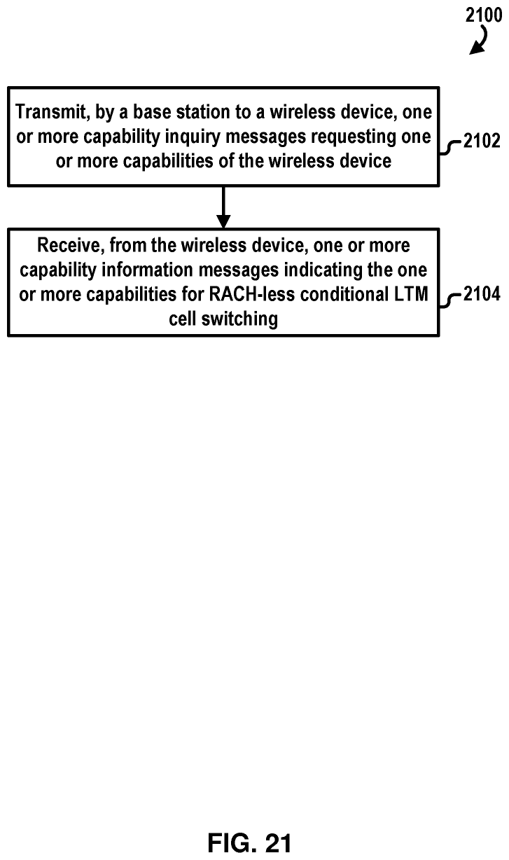

FIG. 21 illustrates a process 2100 according to an embodiment of the present disclosure. The aspects of the process 2100 in FIG. 21 may be implemented by the one or more base stations discussed above in connection with FIGS. 17A, 17B, 18, 19, and/or 20.

Furthermore, any of the aspects, and/or examples, of process 2000 in FIG. 20 from the perspective of the wireless device (e.g., receiver perspective) may be implemented in process 2100 in FIG. 21 from the perspective of a base station (e.g., transmitter perspective). The relationship between the wireless device and the base station may be considered as transmitter-receiver reciprocal relationship. For purposes of brevity, similar features (e.g., that overlap with FIG. 20) will be partially, or entirely, omitted and the discussion below will primarily focus on providing additional details and examples from the perspective of the base station.

As illustrated in FIG. 21, process 2100 comprises a step 2102 of transmitting, by a base station to a wireless device, one or more capability inquiry messages requesting one or more capabilities of the wireless device.

Process 2100 further comprises a step 2104 of receiving, from the wireless device, one or more capability information messages indicating one or more capabilities of the wireless device for RACH-less conditional LTM cell switching.

Additional aspects, with examples, of step 2102, step 2104, and process 2100 are discussed below. Each of the additional aspects, and examples, below may be considered an embodiment. Each aspect of the embodiments may be combined with, or substituted for, the aspects of the embodiment of process 2100 illustrated in FIG. 21, such as step 2102 and/or step 2104. Furthermore, each of the additional aspects and examples below may be combined with each other.

In an example, the one or more capabilities further indicate whether the wireless device supports conditional LTM cell switching.

In an example, the support for the conditional LTM cell switching is support for the conditional LTM cell switching with execution condition and candidate cell configuration.

In an example, the one or more capabilities information messages indicate whether the wireless device supports conditional LTM cell switching for a maximum number of candidate cells.

In an example, the maximum number of candidate cells is up to eight candidate cells.

In an example, the one or more capability information messages indicate, per band, whether the wireless device supports conditional LTM cell switching.

In an example, the one or more capability information messages further indicate one or more capabilities for LTM cell switching based on a command.

In an example, the one or more capabilities for LTM cell switching based on the command comprise one or more capabilities of the wireless device for RACH-less LTM cell switching based on the command.

In an example, the command is a MAC CE or a cell switch command.

In an example, the one or more capabilities indicate whether the wireless device supports RACH-less conditional LTM with an uplink configured grant.

In an example, the RACH-less conditional LTM with the uplink configured grant is for a cell group.

In an example, the cell group is a master cell group (MCG) and/or a secondary cell group (SCG).

In an example, the one or more capabilities indicate, per UE, whether the wireless device supports RACH-less conditional LTM with the uplink configured grant.

In an example, the one or more capabilities indicate whether the wireless device supports RACH-less conditional LTM with a dynamic grant.

In an example, the RACH-less conditional LTM with the dynamic grant is for a cell group.

In an example, the cell group is an MCG and/or an SCG.

In an example, the one or more capabilities indicate, per UE, whether the wireless device supports RACH-less conditional LTM with a dynamic grant.

In an example, process 2100 further comprises a step of transmitting, to the wireless device, one or more RRC messages comprising configuration parameters of a candidate cell for LTM.

In an example, the configuration parameters indicate one or more conditions for performing the conditional LTM cell switching to the one or more candidate cells.

In an example, the one or more conditions are one or more execution conditions.

In an example, the configuration parameters of the candidate cell for LTM are associated with an MCG.

In an example, the configuration parameters of the candidate cell for LTM are associated with the MCG based on a signal radio bearer (SRB) that the one or more RRC messages are transmitted on to the wireless device.

In an example, the configuration parameters of the candidate cell for LTM are associated with a SCG.

In an example, the configuration parameters of the candidate cell for LTM are associated with the SCG based on the SRB that the one or more RRC messages are transmitted on to the wireless device.

In an example, the configuration parameters indicate an uplink configured grant LTM configuration for performing a RACH-less LTM cell switch to the candidate cell.

In an example, the uplink configured grant LTM configuration is a type 1 uplink configured grant configuration.

In an example, an uplink grant of the type 1 uplink configured grant configuration is configured by RRC.

In an example, the uplink grant of the type 1 uplink configured grant configuration is not configured by a downlink control information (DCI).

In an example, the uplink configured grant configuration is associated with a synchronization signal (SS) block (SSB) of the candidate cell.

In an example, the configuration parameters indicate an uplink resource configuration for requesting the dynamic grant.

In an example, the uplink resource configuration is a scheduling request (SR) configuration.

In an example, the uplink resource configuration indicates at least one of: a physical uplink control channel (PUCCH) resource identifier (ID); a periodicity of an uplink resource; and/or a value of a timer.

In an example, the timer is a SR prohibit timer.

In an example, the wireless device triggers a conditional LTM cell switch of a serving cell to the candidate cell based on fulfilling a condition among the one or more conditions.

In an example, the condition is fulfilled based on a comparison of: a radio link quality of a reference signal of the candidate cell and a radio link quality of a reference signal of the serving cell.

In an example, the comparison is of the radio link quality of the reference signal of the candidate cell and the radio link quality of the reference signal of the serving cell to one or more threshold values.

In an example, the one or more threshold values comprise absolute threshold values.

In an example, the one or more threshold values comprise: a threshold value for the radio link quality of the reference signal of the candidate cell; and a threshold value for the radio link quality of the reference signal of the serving cell.

In an example, the one or more threshold values comprise a relative offset value.

In an example, the relative offset value is a differential value between the radio link quality of the reference signal of the candidate cell and the radio link quality of the reference signal of the serving cell.

In an example, the reference signal of the candidate cell is a channel state information reference signal (CSI-RS) of the candidate cell; and the reference signal of the serving cell is a CSI-RS of the serving cell.

In an example, the reference signal of the candidate cell is a synchronization signal (SS) block (SSB) of the candidate cell; and the reference signal of the serving cell is an SSB of the serving cell.

In an example, process 2100 further comprises a step of receiving, from the wireless device, a request for a dynamic grant.

In an example, the dynamic grant is received based on the uplink resource configuration.

In an example, the request is received in response to the uplink configured grant not being valid.

In an example, process 2100 further comprises a step of transmitting, to the wireless device, a DCI indicating the dynamic grant.

In an example, the dynamic grant is transmitted based on receiving the request.

In an example, process 2100 further comprises a step of receiving, from the wireless device on the candidate cell and for the conditional LTM cell switching, an uplink transmission.

In an example, the uplink transmission indicates that an RRC reconfiguration to the candidate cell is complete.

In an example, the uplink transmission a physical uplink shared channel (PUSCH) transmission.

In an example, the PUSCH transmission is based on the uplink configured grant configuration.

In an example, the PUSCH transmission is based on a PUSCH occasion determined based on the SSB indicated by the uplink configured grant configuration.

In an example, the PUSCH transmission is based on a dynamic grant.

In an example, the dynamic grant is indicated by the DCI received after receiving the request for the dynamic grant.

An apparatus (e.g., a base station) comprising one or more processors and memory storing instructions that, when executed by the one or more processors, may cause the apparatus to perform process 2100 and/or any one or more of the above examples.

A (non-transitory) computer-readable medium comprising instructions that, when executed by one or more processors of an apparatus (e.g., a base station), cause the apparatus to perform process 2100 and/or any one or more of the above examples.

A system may comprise: a wireless device that comprising one or more processors and memory storing instructions that, when executed by the one or more processors, cause the wireless device to perform process 2100 and/or any of the above examples; and an apparatus (e.g., a base station) that comprises one or more processors and memory storing instructions that, when executed by the one or more processors, may cause the apparatus to perform process 2100 and/or any one or more of the above examples.

Additional working examples, and embodiments, are provided below. The working examples, and embodiments, may be combined with each other and FIGS. 19, 20, and 21. Additionally or alternatively, the aspects of the working examples, and embodiments provided below may be substituted for any of the aspects of FIGS. 19, 20, and 21.

A wireless device may receive, from a base station, a UE capability enquiry message (e.g., UECapabilityEnquiry). The wireless device may transmit, to the base station, a capability information message (e.g., UECapabilityInformation, UE capability information message), for example, based on receiving the UE capability enquiry message. The base station may receive the capability information message.

The capability information message may comprise a first parameter (e.g., ltm-RACH-LessCG, Cond-ltm-RACH-LessCG, and the like).

The first parameter may indicate whether the wireless device supports RACH-less LTM with configured grant, for example, for MCG LTM if the wireless device indicates, by an MCG parameter (e.g., ltm-MCG-IntraFreq) in the capability information message, support of intra-frequency LTM for MCG with RACH without NR-DC configured. The first parameter may indicate whether the wireless device supports RACH-less LTM with configured grant, for example, for SCG LTM if the wireless device indicates, by an SCG parameter (e.g., ltm-SCG-IntraFreq) in the capability information message, support of intra-frequency LTM for SCG with RACH.

The first parameter may indicate whether the wireless device supports RACH-less conditional LTM with configured grant, for example, for MCG LTM if the wireless device indicates, by an MCG parameter (e.g., ltm-MCG-IntraFreq) in the capability information message, support of intra-frequency LTM for MCG with RACH without NR-DC configured. The first parameter may indicate whether the wireless device supports RACH-less conditional LTM with configured grant, for example, for SCG LTM if the wireless device indicates, by an SCG parameter (e.g., ltm-SCG-IntraFreq) in the capability information message, support of intra-frequency LTM for SCG with RACH.

The first parameter may indicate whether the wireless device supports RACH-less conditional LTM with configured grant, for example, for MCG LTM if the wireless device indicates, by an MCG parameter (e.g., ltm-MCG-IntraFreq) in the capability information message, support of intra-frequency conditional LTM for MCG with RACH without NR-DC configured. The first parameter may indicate whether the wireless device supports RACH-less conditional LTM with configured grant, for example, for SCG LTM if the wireless device indicates, by an SCG parameter (e.g., ltm-SCG-IntraFreq) in the capability information message, support of intra-frequency conditional LTM for SCG with RACH.

The first parameter may be (or may be interchangeably used with) a first feature.

The wireless device indicating the first parameter (or the first feature) in the capability information message may indicate, in the capability information message, support of conditional LTM cell switch (e.g., conditionalLTMCellSwitch), for example, for at least one band. The wireless device indicating support of RACH-less LTM with configured grant by the first parameter may indicate, by a conditional LTM parameter (e.g., conditionalLTMCellSwitch) in the capability information message, support of conditional LTM cell switch, for example, for at least one band.

The wireless device indicating the first parameter (or the first feature) in the capability information message may indicate, in the capability information message, support of conditional LTM cell switch (e.g., conditionalLTMCellSwitch), for example, for at least one band. The wireless device indicating support of RACH-less conditional LTM with configured grant by the first parameter may indicate, by a conditional LTM parameter (e.g., conditionalLTMCellSwitch) in the capability information message, support of conditional LTM cell switch, for example, for at least one band.

The wireless device indicating the first parameter in the capability information message may indicate the conditional LTM parameter (e.g., conditionalLTMCellSwitch) in the capability information message.

The wireless device indicating the first parameter (or the first feature) in the capability information message may indicate, in the capability information message, support of TA indication in a message (e.g., RAR or MAC-CE) for LTM. The wireless device indicating support of RACH-less LTM with configured grant by the first parameter may indicate, by a TA indication parameter (e.g., ta-IndicationRAR or ta-IndicationMAC-CE) in the capability information message, support of TA indication in a message (e.g., RAR or MAC-CE) for LTM.

The wireless device indicating the first parameter (or the first feature) in the capability information message may indicate, in the capability information message, support of TA indication in a message (e.g., RAR or MAC-CE) for conditional LTM. The wireless device indicating support of RACH-less conditional LTM with configured grant by the first parameter may indicate, by a TA indication parameter (e.g., ta-IndicationRAR or ta-IndicationMAC-CE) in the capability information message, support of TA indication in a message (e.g., RAR or MAC-CE) for conditional LTM.

The wireless device indicating the first parameter in the capability information message may indicate the TA indication parameter (e.g., ta-IndicationRAR or ta-IndicationMAC-CE) in the capability information message.

The message may be different from an LTM cell switch command MAC-CE. The TA indication parameter may be different from a second TA indication parameter (e.g., ta-IndicationCellSwitch) that indicates support of TA indication in an LTM cell switch command MAC-CE. The wireless device may receive the message indicating a TA, for example, for early uplink synchronization. The wireless device may receive the message indicating a TA, for example, before triggering/initiating a conditional LTM cell switch.

In an example, the first parameter may be different from a configured grant parameter (e.g., ltm-RACH-LessCG) that indicates whether the wireless device supports RACH-less LTM with configured grant. The RACH-less LTM may be a RACH-less LTM cell switching based on a command (e.g., LTM cell switch command MAC-CE). In an example, the capability information message may comprise the configured grant parameter. In an example, the capability information message may not comprise the configured grant parameter. The first parameter may indicate whether the wireless device supports RACH-less conditional LTM with configured grant. The RACH-less conditional LTM may be a RACH-less conditional LTM cell switching.

In an example, the first parameter may be the same as a configured grant parameter (e.g., ltm-RACH-LessCG). The first parameter (or the configured grant parameter) may indicate whether the wireless device supports RACH-less LTM with configured grant. The RACH-less LTM may comprise a RACH-less LTM cell switching based on a command (e.g., LTM cell switch command MAC-CE) and a RACH-less conditional LTM cell switching.

The wireless device may transmit/signal the first parameter per UE.

The base station may transmit, to the wireless device, one or more messages (e.g., RRC message(s), RRC reconfiguration message(s)) comprising one or more configuration parameters.

The one or more configuration parameters may indicate a configured uplink grant (e.g., Type 1 configured uplink grant) for LTM (or for a conditional LTM cell switching). The one or more configuration parameters may indicate the configured uplink grant for the LTM (or for the conditional LTM cell switching), for example, based on the capability information message comprising the first parameter (e.g., ltm-RACH-LessCG, Cond-ltm-RACH-LessCG, and the like) that indicates support of RACH-less LTM with configured grant. The one or more configuration parameters may indicate the configured uplink grant for the LTM (or for the conditional LTM cell switching), for example, based on the capability information message comprising the first parameter (e.g., ltm-RACH-LessCG, Cond-ltm-RACH-LessCG, and the like) that indicates support of RACH-less conditional LTM with configured grant.

After triggering a conditional LTM cell switch, the wireless device may transmit an uplink transmission (e.g., PUSCH transmission) via/in a transmission occasion of the configured uplink grant. The wireless device may transmit, for the triggered conditional LTM cell switch, the uplink transmission (e.g., PUSCH transmission) via/in the transmission occasion of the configured uplink grant.

For another wireless device that does not indicate support of RACH-less LTM (or RACH-less conditional LTM) with configured grant in a capability information message, one or more second configuration parameters, transmitted to this wireless device by the base station, may not indicate a configured uplink grant for the LTM (or for an conditional LTM cell switching). For another wireless device that does not indicate support of RACH-less LTM (or RACH-less conditional LTM) with configured grant in a capability information message, one or more second configuration parameters, transmitted to this wireless device by the base station, may indicate RACH configuration/resources for the LTM (or for a conditional LTM cell switching).

The capability information message may comprise a second parameter (e.g., ltm-RACH-LessDG, Cond-ltm-RACH-LessDG, and the like).

The second parameter may indicate whether the wireless device supports RACH-less LTM with dynamic grant, for example, for MCG LTM if the wireless device indicates, by an MCG parameter (e.g., ltm-MCG-IntraFreq) in the capability information message, support of intra-frequency LTM for MCG with RACH without NR-DC configured. The second parameter may indicate whether the wireless device supports RACH-less LTM with dynamic grant, for example, for SCG LTM if the wireless device indicates, by an SCG parameter (e.g., ltm-SCG-IntraFreq) in the capability information message, support of intra-frequency LTM for SCG with RACH.

The second parameter may indicate whether the wireless device supports RACH-less conditional LTM with dynamic grant, for example, for MCG LTM if the wireless device indicates, by an MCG parameter (e.g., ltm-MCG-IntraFreq) in the capability information message, support of intra-frequency LTM for MCG with RACH without NR-DC configured. The second parameter may indicate whether the wireless device supports RACH-less conditional LTM with dynamic grant, for example, for SCG LTM if the wireless device indicates, by an SCG parameter (e.g., ltm-SCG-IntraFreq) in the capability information message, support of intra-frequency LTM for SCG with RACH.

The second parameter may indicate whether the wireless device supports RACH-less conditional LTM with dynamic grant, for example, for MCG LTM if the wireless device indicates, by an MCG parameter (e.g., ltm-MCG-IntraFreq) in the capability information message, support of intra-frequency conditional LTM for MCG with RACH without NR-DC configured. The second parameter may indicate whether the wireless device supports RACH-less conditional LTM with dynamic grant, for example, for SCG LTM if the wireless device indicates, by an SCG parameter (e.g., ltm-SCG-IntraFreq) in the capability information message, support of intra-frequency conditional LTM for SCG with RACH.

The second parameter may be (or may be interchangeably used with) a second feature.

The wireless device indicating the second parameter (or the second feature) in the capability information message may indicate, in the capability information message, support of conditional LTM cell switch (e.g., conditionalLTMCellSwitch), for example, for at least one band. The wireless device indicating support of RACH-less LTM with dynamic grant by the second parameter may indicate, by a conditional LTM parameter (e.g., conditionalLTMCellSwitch) in the capability information message, support of conditional LTM cell switch, for example, for at least one band.

The wireless device indicating the second parameter (or the second feature) in the capability information message may indicate, in the capability information message, support of conditional LTM cell switch (e.g., conditionalLTMCellSwitch), for example, for at least one band. The wireless device indicating support of RACH-less conditional LTM with dynamic grant by the second parameter may indicate, by a conditional LTM parameter (e.g., conditionalLTMCellSwitch) in the capability information message, support of conditional LTM cell switch, for example, for at least one band.

The wireless device indicating the second parameter in the capability information message may indicate the conditional LTM parameter (e.g., conditionalLTMCellSwitch) in the capability information message.

The wireless device indicating the second parameter (or the second feature) in the capability information message may indicate, in the capability information message, support of TA indication in a message (e.g., RAR or MAC-CE) for LTM. The wireless device indicating support of RACH-less LTM with dynamic grant by the second parameter may indicate, by a TA indication parameter (e.g., ta-IndicationRAR or ta-IndicationMAC-CE) in the capability information message, support of TA indication in a message (e.g., RAR or MAC-CE) for LTM.

The wireless device indicating the second parameter (or the second feature) in the capability information message may indicate, in the capability information message, support of TA indication in a message (e.g., RAR or MAC-CE) for conditional LTM. The wireless device indicating support of RACH-less conditional LTM with dynamic grant by the second parameter may indicate, by a TA indication parameter (e.g., ta-IndicationRAR or ta-IndicationMAC-CE) in the capability information message, support of TA indication in a message (e.g., RAR or MAC-CE) for conditional LTM.

The wireless device indicating the second parameter in the capability information message may indicate the TA indication parameter (e.g., ta-IndicationRAR or ta-IndicationMAC-CE) in the capability information message.

The message may be different from an LTM cell switch command MAC-CE. The TA indication parameter may be different from a second TA indication parameter (e.g., ta-IndicationCellSwitch) that indicates support of TA indication in an LTM cell switch command MAC-CE. The wireless device may receive the message indicating a TA, for example, for early uplink synchronization. The wireless device may receive the message indicating a TA, for example, before triggering/initiating a conditional LTM cell switch.

In an example, the second parameter may be different from a dynamic grant parameter (e.g., ltm-RACH-LessDG) that indicates whether the wireless device supports RACH-less LTM with dynamic grant. The RACH-less LTM may be a RACH-less LTM cell switching based on a command (e.g., LTM cell switch command MAC-CE). In an example, the capability information message may comprise the dynamic grant parameter. In an example, the capability information message may not comprise the dynamic grant parameter. The second parameter may indicate whether the wireless device supports RACH-less conditional LTM with dynamic grant. The RACH-less conditional LTM may be a RACH-less conditional LTM cell switching.

In an example, the second parameter may be the same as a dynamic grant parameter (e.g., ltm-RACH-LessDG). The second parameter (or the dynamic grant parameter) may indicate whether the wireless device supports RACH-less LTM with dynamic grant. The RACH-less LTM may comprise a RACH-less LTM cell switching based on a command (e.g., LTM cell switch command MAC-CE) and a RACH-less conditional LTM cell switching.

The wireless device may transmit/signal the second parameter per UE.

The wireless device may trigger a conditional LTM cell switch. After triggering the conditional LTM cell switch, the base station may transmit, to the wireless device, a DCI indicating/comprising an uplink grant (e.g., a dynamic grant). The wireless device may transmit an uplink transmission (e.g., PUSCH transmission) via/using the uplink grant. The wireless device may transmit, for the triggered conditional LTM cell switch, the uplink transmission (e.g., PUSCH transmission).

The base station may transmit, to the wireless device, the DCI indicating/comprising the uplink grant, for example, based on the capability information message comprising the second parameter (e.g., ltm-RACH-LessDG, Cond-ltm-RACH-LessDG, and the like) that indicates support of RACH-less LTM with dynamic grant. The base station may transmit, to the wireless device, the DCI indicating/comprising the uplink grant, for example, based on the capability information message comprising the second parameter (e.g., ltm-RACH-LessDG, Cond-ltm-RACH-LessDG, and the like) that indicates support of RACH-less conditional LTM with dynamic grant.

The base station may transmit, to the wireless device, one or more messages (e.g., RRC message(s), RRC reconfiguration message(s)) comprising one or more configuration parameters.

The one or more configuration parameters may comprise an uplink configuration (e.g., PUCCH resource, SR configuration, PUSCH resource) for LTM (or for a conditional LTM cell switching). The uplink configuration may be, for example, for requesting an uplink resource to transmit the uplink transmission for the conditional LTM cell switch. The wireless device may transmit, for the triggered conditional LTM cell switch, the uplink transmission via the uplink resource. The uplink configuration may be, for example, for notification/indication of the triggered conditional LTM cell switch. The base station may transmit the DCI, for example, after receiving an uplink signal (e.g., UCI, MAC-CE, SR) via a first uplink resource (e.g., PUCCH resource, SR resource, PUSCH resource) of the uplink configuration.

The one or more configuration parameters may indicate the uplink configuration for the LTM (or for the conditional LTM cell switching), for example, based on the capability information message comprising the second parameter (e.g., ltm-RACH-LessDG, Cond-ltm-RACH-LessDG, and the like) that indicates support of RACH-less LTM with dynamic grant. The one or more configuration parameters may indicate the uplink configuration for the LTM (or for the conditional LTM cell switching), for example, based on the capability information message comprising the second parameter (e.g., ltm-RACH-LessDG, Cond-ltm-RACH-LessDG, and the like) that indicates support of RACH-less conditional LTM with dynamic grant.

For another wireless device that does not indicate support of RACH-less LTM (or RACH-less conditional LTM) with dynamic grant in a capability information message, one or more second configuration parameters, transmitted to this wireless device by the base station, may not indicate an uplink configuration for the LTM (or for a conditional LTM cell switching). For another wireless device that does not indicate support of RACH-less LTM (or RACH-less conditional LTM) with configured grant in a capability information message, the base station may not transmit, to this wireless device, a DCI indicating an uplink grant for an uplink transmission of a conditional LTM cell switching.

For another wireless device that does not indicate support of RACH-less LTM (or RACH-less conditional LTM) with dynamic grant in a capability information message, one or more second configuration parameters, transmitted to this wireless device by the base station, may indicate a configured uplink grant or a RACH configuration/resource for the LTM (or for a conditional LTM cell switching).

The capability information message may comprise a third parameter (e.g., ltm-MAC-CE-JointTCI). The third parameter may indicate whether the wireless device supports MAC-CE activated joint LTM TCI states.

The third parameter may be (or may be interchangeably used with) a third feature.

The third parameter (or capability of supporting MAC-CE activated joint LTM TCI states) may comprise a QCL resource parameter (e.g., qcl-Resource) that indicates a supported QCL source RS for MAC-CE activated joint LTM TCI states configuration.

The third parameter (or capability of supporting MAC-CE activated joint LTM TCI states) may comprise a maximum TCI state number (e.g., maxNumberJointTCI-PerCell) that indicates a maximum number of MAC-CE activated joint LTM TCI states per candidate cell.

The third parameter (or capability of supporting MAC-CE activated joint LTM TCI states) may comprise a second maximum TCI state number (e.g., maxNumberJointTCI-AcrossCells) that indicates a maximum number of MAC-CE activated joint LTM TCI states across candidate cells and serving cells.

The wireless device indicating the third parameter (or the third feature) in the capability information message may indicate, in the capability information message, support of conditional LTM cell switch (e.g., conditionalLTMCellSwitch). The wireless device supporting MAC-CE activated joint LTM TCI states may indicate, by a conditional LTM parameter (e.g., conditionalLTMCellSwitch) in the capability information message, support of conditional LTM cell switch. The wireless device indicating the third parameter in the capability information message may indicate the conditional LTM parameter (e.g., conditionalLTMCellSwitch) in the capability information message.

The wireless device may transmit the third parameter per band. The wireless device may indicate support of MAC-CE activated joint LTM TCI states, for example, per band. The capability information message may comprise the third parameter for a first band and the third parameter for a second band. The third parameter for the first band may be different from the third parameter for the second band. The third parameter for the first band may indicate support of MAC-CE activated joint LTM TCI states for the first band. The third parameter for the second band may indicate support of MAC-CE activated joint LTM TCI states for the second band.

The base station may transmit, to the wireless device, a candidate cell TCI states activation/deactivation MAC CE (e.g., MAC CE 1808 in FIG. 18) indicating activation of one or more joint TCI states. The wireless device may receive, from the base station, the candidate cell TCI states activation/deactivation MAC CE (e.g., MAC CE 1808 in FIG. 18) indicating activation of the one or more joint TCI states.

The base station may transmit, to the wireless device, the candidate cell TCI states activation/deactivation MAC CE indicating activation of the one or more joint TCI states, for example, based on the capability information message comprising the third parameter (e.g., ltm-MAC-CE-JointTCI) that indicates support of MAC-CE activated joint LTM TCI states. The wireless device may receive, from the base station, the candidate cell TCI states activation/deactivation MAC CE indicating activation of the one or more joint TCI states, for example, based on the capability information message comprising the third parameter (e.g., ltm-MAC-CE-JointTCI) that indicates support of MAC-CE activated joint LTM TCI states.

For another wireless device that does not indicate support of MAC-CE activated joint LTM TCI states, the base station may not transmit, to this wireless device, a candidate cell TCI states activation/deactivation MAC CE indicating activation of joint LTM TCI state(s).

The capability information message may comprise a fourth parameter (e.g., ltm-MAC-CE-SeparateTCI). The fourth parameter may indicate whether the wireless device supports MAC-CE activated downlink/uplink LTM TCI states.

The fourth parameter may be (or may be interchangeably used with) a fourth feature.

The fourth parameter (or capability of supporting MAC-CE activated downlink/uplink LTM TCI states) may comprise a QCL resource parameter (e.g., qcl-Resource) that indicates a supported QCL source RS for MAC-CE activated downlink/uplink LTM TCI states configuration.

The fourth parameter (or capability of supporting MAC-CE activated downlink/uplink LTM TCI states) may comprise a maximum downlink TCI state number (e.g., maxNumberDL-TCI-PerCell) that indicates a maximum number of MAC-CE activated downlink LTM TCI states per candidate cell. The fourth parameter (or capability of supporting MAC-CE activated downlink/uplink LTM TCI states) may comprise a maximum uplink TCI state number (e.g., maxNumberUL-TCI-PerCell) that indicates a maximum number of MAC-CE activated uplink LTM TCI states per candidate cell.

The fourth parameter (or capability of supporting MAC-CE activated downlink/uplink LTM TCI states) may comprise a second maximum downlink TCI state number (e.g., maxNumberDL-TCI-AcrossCells) that indicates a maximum number of MAC-CE activated downlink LTM TCI states across candidate cells and serving cells.

The fourth parameter (or capability of supporting MAC-CE activated downlink/uplink LTM TCI states) may comprise a second maximum uplink TCI state number (e.g., maxNumberUL-TCI-AcrossCells) that indicates a maximum number of MAC-CE activated uplink LTM TCI states across candidate cells and serving cells.

The wireless device indicating the fourth parameter (or the fourth feature) in the capability information message may indicate, in the capability information message, support of conditional LTM cell switch (e.g., conditionalLTMCellSwitch). The wireless device supporting MAC-CE activated downlink/uplink LTM TCI states may indicate, by a conditional LTM parameter (e.g., conditionalLTMCellSwitch) in the capability information message, support of conditional LTM cell switch. The wireless device indicating the fourth parameter in the capability information message may indicate the conditional LTM parameter (e.g., conditionalLTMCellSwitch) in the capability information message.

The wireless device may transmit the fourth parameter per band. The wireless device may indicate support of MAC-CE activated downlink/uplink LTM TCI states, for example, per band. The capability information message may comprise the fourth parameter for a first band and the fourth parameter for a second band. The fourth parameter for the first band may be different from the fourth parameter for the second band. The fourth parameter for the first band may indicate support of MAC-CE activated downlink/uplink LTM TCI states for the first band. The fourth parameter for the second band may indicate support of MAC-CE activated downlink/uplink LTM TCI states for the second band.

The base station may transmit, to the wireless device, a candidate cell TCI states activation/deactivation MAC CE (e.g., MAC CE 1808 in FIG. 18) indicating activation of one or more downlink/uplink TCI states. The wireless device may receive, from the base station, the candidate cell TCI states activation/deactivation MAC CE (e.g., MAC CE 1808 in FIG. 18) indicating activation of the one or more downlink/uplink TCI states.

The base station may transmit, to the wireless device, the candidate cell TCI states activation/deactivation MAC CE indicating activation of the one or more downlink/uplink TCI states, for example, based on the capability information message comprising the fourth parameter (e.g., ltm-MAC-CE-SeparateTCI) that indicates support of MAC-CE activated downlink/uplink LTM TCI states. The wireless device may receive, from the base station, the candidate cell TCI states activation/deactivation MAC CE indicating activation of the one or more downlink/uplink TCI states, for example, based on the capability information message comprising the fourth parameter (e.g., ltm-MAC-CE-SeparateTCI) that indicates support of MAC-CE activated downlink/uplink LTM TCI states.

For another wireless device that does not indicate support of MAC-CE activated downlink/uplink LTM TCI states, the base station may not transmit, to this wireless device, a candidate cell TCI states activation/deactivation MAC CE indicating activation of downlink/uplink LTM TCI state(s).

A wireless device may receive, from a base station, a UE capability enquiry message (e.g., UECapabilityEnquiry). The wireless device may transmit, to the base station, a capability information message (e.g., UECapabilityInformation, UE capability information message), for example, based on receiving the UE capability enquiry message. The base station may receive the capability information message.

The capability information message may comprise a first parameter (e.g., condLTM-CellSwitchFailure). The first parameter may indicate whether the wireless device supports conditional LTM cell switch during re-establishment procedure when the selected cell is configured as a candidate cell for the conditional LTM cell switch.

The first parameter may be different from a conditional handover failure parameter (e.g., condHandoverFailure) that indicates whether the wireless device supports conditional handover during re-establishment procedure when the selected cell is configured as a candidate cell for the conditional handover. The conditional handover may be, for example, L3-triggered conditional handover. In an example, the capability information message may comprise the conditional handover failure parameter. In an example, the capability information message may not comprise the conditional handover failure parameter.

The wireless device may transmit/signal the first parameter, for example, per band.

The capability information message may comprise a second parameter (e.g., condLTM-CellSwitchTwoTriggerEvents). The second parameter may indicate whether the wireless device supports a number of trigger events for the same execution condition of a conditional LTM cell switch. In an example, the number may be two. In an example, the number may be three. In an example, the number may be three.

The wireless device may support the number of trigger events for the same execution condition of a conditional LTM cell switch, for example, based on supporting conditional LTM cell switch. The capability information message may comprise a conditional LTM cell switch parameter (e.g., conditionalLTMCellSwitch) indicating support of the conditional LTM cell switch.

The second parameter may be different from a trigger-event parameter (e.g., condHandoverTwoTriggerEvents) that indicates whether the wireless device supports a number of trigger events for the same execution condition of a conditional handover. The number may be, for example, two. The conditional handover may be, for example, L3-triggered conditional handover. In an example, the capability information message may comprise the trigger-event parameter. In an example, the capability information message may not comprise the trigger-event parameter.

The wireless device may transmit/signal the second parameter, for example, per band.

The capability information message may comprise a third parameter (e.g., condLTM-CellSwitchWithCandSCG-change). The third parameter may indicate whether the wireless device supports conditional LTM cell switch with candidate SCG. The conditional NR PSCell change may be supported, for example, for FDD-FR1 bands, TDD-FR1 bands, TDD-FR2-1 bands and TDD-FR2-2 bands.

The wireless device indicating, by the third parameter, support of conditional LTM cell switch with candidate SCG may indicate, by a conditional LTM cell switch parameter (e.g., conditionalLTMCellSwitch) in the capability information message, support of conditional LTM cell switch.

The wireless device indicating, by the third parameter, support of conditional LTM cell switch with candidate SCG may indicate support of at least one NR-DC band combination. The wireless device indicating, by the third parameter, support of conditional LTM cell switch with candidate SCG may indicate, by a parameter in the capability information message, support of at least one NR-DC band combination.

The third parameter may be different from a candidate cell change parameter (e.g., condHandoverWithCandSCG-change) that indicates whether the wireless device supports conditional handover with candidate SCG. The conditional NR PSCell change may be supported, for example, for FDD-FR1 bands, TDD-FR1 bands, TDD-FR2-1 bands and TDD-FR2-2 bands. The conditional handover may be, for example, L3-triggered conditional handover. In an example, the capability information message may comprise the candidate cell change parameter. In an example, the capability information message may not comprise the candidate cell change parameter.

The wireless device may transmit/signal the second parameter, for example, per band.

In an example, the wireless device may set the capability value of the third parameter consistently for all FDD-FR1 bands, all TDD-FR1 bands, all TDD-FR2-1 bands and all TDD-FR2-2 bands, respectively.

The capability information message may comprise a fourth parameter (e.g., condLTM-CellSwitchWithCandSCG-FDD-TDD-change). The fourth parameter may indicate whether the wireless device supports conditional LTM cell switch with candidate SCG. The conditional NR PSCell change may be supported between FDD and TDD.

The fourth parameter may be set/present, for example, based on a conditional LTM cell switch parameter (e.g., condLTM-CellSwitchWithCandSCG-change) being set for both FDD and TDD. The fourth parameter may not be set/present, for example, based on a conditional LTM cell switch parameter (e.g., condLTM-CellSwitchWithCandSCG-change) not being set for both FDD and TDD.

The fourth parameter may be different from a conditional handover cell change parameter (e.g., condHandoverWithCandSCG-FDD-TDD-change) that indicates whether the wireless device supports conditional handover with candidate SCG. The conditional NR PSCell change may be supported between FDD and TDD. The conditional handover may be, for example, L3-triggered conditional handover. In an example, the capability information message may comprise the conditional handover cell change parameter. In an example, the capability information message may not comprise the conditional handover cell change parameter.

The wireless device may transmit/signal the fourth parameter, for example, per UE. The fourth parameter may be transmitted/signaled, for example, per UE.

The capability information message may comprise a fifth parameter (e.g., condLTM-CellSwitchWithCandSCG-FR1-FR2-change). The fifth parameter may indicate whether the wireless device supports conditional LTM cell switch with candidate SCG. The conditional NR PSCell change may be supported between FR1 and FR2.

The fifth parameter may be set/present, for example, based on a conditional LTM cell switch parameter (e.g., condLTM-CellSwitchWithCandSCG-change) being set for both FR1 and FR2. The fifth parameter may not be set/present, for example, based on a conditional LTM cell switch parameter (e.g., condLTM-CellSwitchWithCandSCG-change) not being set for both FR1 and FR2.

The fifth parameter may be different from a second conditional handover cell change parameter (e.g., condHandoverWithCandSCG-FR1-FR2-change) that indicates whether the wireless device supports conditional handover with candidate SCG. The conditional NR PSCell change may be supported between FR1 and FR2. The conditional handover may be, for example, L3-triggered conditional handover. In an example, the capability information message may comprise the second conditional handover cell change parameter. In an example, the capability information message may not comprise the second conditional handover cell change parameter.

The wireless device may transmit/signal the fifth parameter, for example, per UE. The fifth parameter may be transmitted/signaled, for example, per UE.

What is claimed is:

1. A method comprising:
transmitting, by a wireless device, one or more capability information messages indicating one or more capabilities of the wireless device, wherein the one or more capabilities indicate that:
the wireless device supports conditional layer-1/layer-2 triggered mobility (LTM) cell switching; and
the wireless device supports random access channel (RACH)-less conditional LTM with an uplink configured grant for a master cell group (MCG);
receiving one or more radio resource control (RRC) messages comprising configuration parameters of a candidate cell for conditional LTM cell switching, wherein the configuration parameters indicate a first uplink configured grant configuration for performing a RACH-less LTM cell switch to the candidate cell;
triggering a conditional LTM cell switch of a primary cell to the candidate cell in response to a condition being fulfilled; and
transmitting, on the candidate cell and for the conditional LTM cell switch, an uplink transmission based on the first uplink configured grant configuration.

2. The method of claim 1, wherein the one or more capability information messages comprise:
a first parameter indicating that the wireless device supports conditional LTM cell switching; and
a second parameter indicating that the wireless device supports RACH-less conditional LTM with the uplink configured grant.

3. The method of claim 2, wherein the second parameter further indicates that the wireless device supports RACH-less LTM cell switching based on a cell switch command.

4. The method of claim 3, wherein the cell switch command is a cell switch command medium access control (MAC) control element (CE).

5. The method of claim 1, wherein:
the one or more capability information messages indicate, per user equipment (UE), whether the wireless device supports conditional LTM cell switching; and
the one or more capability information messages indicate, per UE, whether the wireless device supports RACH-less conditional LTM with the uplink configured grant for the MCG.

6. The method of claim 1, wherein:
the configuration parameters of the candidate cell for LTM are associated with the MCG; and
the configuration parameters of the candidate cell for LTM are associated with the MCG based on receiving the one or more RRC messages on a first signaling radio bearer (SRB).

7. The method of claim 1, wherein the first uplink configured grant configuration is a type 1 uplink configured grant configuration.

8. A wireless device comprising:
one or more processors; and
memory storing instructions that, when executed by the one or more processors, cause the wireless device to:
transmit one or more capability information messages indicating one or more capabilities of the wireless device, wherein the one or more capabilities indicate that:
the wireless device supports conditional layer-1/layer-2 triggered mobility (LTM) cell switching; and
the wireless device supports random access channel (RACH)-less conditional LTM with an uplink configured grant for a master cell group (MCG);
receive one or more radio resource control (RRC) messages comprising configuration parameters of a candidate cell for conditional LTM cell switching, wherein the configuration parameters indicate a first uplink configured grant configuration for performing a RACH-less LTM cell switch to the candidate cell;
trigger a conditional LTM cell switch of a primary cell to the candidate cell in response to a condition being fulfilled; and
transmit, on the candidate cell and for the conditional LTM cell switch, an uplink transmission based on the first uplink configured grant configuration.

9. The wireless device of claim 8, wherein the one or more capability information messages comprise:
a first parameter indicating that the wireless device supports conditional LTM cell switching; and
a second parameter indicating that the wireless device supports RACH-less conditional LTM with the uplink configured grant.

10. The wireless device of claim 9, wherein the second parameter further indicates that the wireless device supports RACH-less LTM cell switching based on a cell switch command.

11. The wireless device of claim 10, wherein the cell switch command is a cell switch command medium access control (MAC) control element (CE).

12. The wireless device of claim 8, wherein:
the one or more capability information messages indicate, per user equipment (UE), whether the wireless device supports conditional LTM cell switching; and
the one or more capability information messages indicate, per UE, whether the wireless device supports RACH-less conditional LTM with the uplink configured grant for the MCG.

13. The wireless device of claim 8, wherein:
the configuration parameters of the candidate cell for LTM are associated with the MCG; and
the configuration parameters of the candidate cell for LTM are associated with the MCG based on receiving the one or more RRC messages on a first signaling radio bearer (SRB).

14. The wireless device of claim 8, wherein the first uplink configured grant configuration is a type 1 uplink configured grant configuration.

15. A non-transitory computer-readable medium comprising instructions that, when executed by one or more processors of a wireless device, cause the wireless device to:
transmit one or more capability information messages indicating one or more capabilities of the wireless device, wherein the one or more capabilities indicate that:
the wireless device supports conditional layer-1/layer-2 triggered mobility (LTM) cell switching; and
the wireless device supports random access channel (RACH)-less conditional LTM with an uplink configured grant for a master cell group (MCG);
receive one or more radio resource control (RRC) messages comprising configuration parameters of a candidate cell for conditional LTM cell switching, wherein the configuration parameters indicate a first uplink configured grant configuration for performing a RACH-less LTM cell switch to the candidate cell;
trigger a conditional LTM cell switch of a primary cell to the candidate cell in response to a condition being fulfilled; and
transmit, on the candidate cell and for the conditional LTM cell switch, an uplink transmission based on the first uplink configured grant configuration.

16. The non-transitory computer-readable medium of claim 15, wherein the one or more capability information messages comprise:
a first parameter indicating that the wireless device supports conditional LTM cell switching; and
a second parameter indicating that the wireless device supports RACH-less conditional LTM with the uplink configured grant.

17. The non-transitory computer-readable medium of claim 16, wherein the second parameter further indicates that the wireless device supports RACH-less LTM cell switching based on a cell switch command.

18. The non-transitory computer-readable medium of claim 17, wherein the cell switch command is a cell switch command medium access control (MAC) control element (CE).

19. The non-transitory computer-readable medium of claim 15, wherein:
the one or more capability information messages indicate, per user equipment (UE), whether the wireless device supports conditional LTM cell switching; and
the one or more capability information messages indicate, per UE, whether the wireless device supports RACH-less conditional LTM with the uplink configured grant for the MCG.

20. The non-transitory computer-readable medium of claim 15, wherein:
the configuration parameters of the candidate cell for LTM are associated with the MCG; and
the configuration parameters of the candidate cell for LTM are associated with the MCG based on receiving the one or more RRC messages on a first signaling radio bearer (SRB).
